(19) United States
(12) Patent Application Publication
(10) Pub. No.: US 2025/0342519 A1
(43) Pub. Date: Nov. 6, 2025

(54) Ecommerce messaging systems and methods for implementing in-app stores and order workflows

(71) Applicants: Joseph C. Cheng, Brookline, MA (US); Doris L. Cheng, Brookline, MA (US)

(72) Inventors: Joseph C. Cheng, Brookline, MA (US); Doris L. Cheng, Brookline, MA (US)

(73) Assignees: Joseph C. Cheng, Brookline, MA (US); Doris L. Cheng, Brookline, MA (US)

(21) Appl. No.: 18/655,276

(22) Filed: May 5, 2024

(51) Int. Cl. G06Q 30/0601; G06F 9/54

(52) U.S. Cl. CPC G06Q 30/0641; G06F 9/547; G06Q 30/0633

(57) ABSTRACT

An ecommerce messaging system described herein comprises one or more ecommerce extension apps that interact with a messaging app. These embodiments leverage the extension core to manage session apps and smart services for using tap-to-message and tap-to-update processes to generate, update, and manage order workflows and in-app stores through branded messages communicated between customer and seller session apps to share message transcripts on devices of the same user groups via the messaging host, empower ecommerce with action-key-based communication, serialize-deserialize processes, and dynamic update propagation, manage return-refund workflows with temporary tables until one-time entity data model updates can be performed for session apps, and configure multi-store shopping systems on sellers' multiple devices using a store-as-a-service model to enable distributors to distribute production copies of assigned stores to authorized publishers to add custom promotions, which will be published together as production copies to their subscribed user groups for multi-store shopping and tracking.

### TECHNICAL FIELD

The present disclosure relates generally to facilitating ecommerce within a messaging app. Specifically, one or more ecommerce extension apps relate to creating and managing in-app stores and order workflows by processing branded messages communicated between session app users via a messaging app.

### BACKGROUND

Online ecommerce sales and returns are growing. A 2024 quarterly retail ecommerce sales report by the U.S. Census Bureau revealed that online sales accounted for about 15.4% of total U.S. retail sales in 2023, reaching $1,118.7 billion. Furthermore, a National Retail Federation (NRF) sales survey found that the average online return rate increased to 17.6% in 2023.

Leading ecommerce player Amazon (Seattle, WA) offers Seller Central platform to allow sellers to leverage Amazon's marketing and distribution systems, Amazon Prime to provides subscribers with free shipping as incentives, and Amazon Inspire short video feed for live shopping experience. Similarly, competitors like Walmart (Rogers, AR) and Home Depot (Atlanta, GA) rely on client-server systems with fulfillment services and add-on online chat capabilities. Further, Meta Platforms (Menlo Park, CA) has enabled online sales to social media users through its Facebook Shop and Instagram Direct platforms. No to be outdone, ByteDance (China) positions its TikTok short video app as a shopping platform with its own Seller Center. These ecommerce and social networking websites are powered by complex client-server systems, supplemented with messaging services, and monetized with advertising and influencer partnerships.

Client-server systems can be expensive to manage and maintain. Saas (Software as a Service) ecommerce platforms like Shopify (Ottawa, Ontario) and BigCommerce (Austin, TX) offer multi-store solutions for additional monthly fees. However, these platforms are limited to one store per account. Additionally, impromptu system upgrades for ecommerce websites hosted on Amazon Web Services can divert attention away from core business activities. As illustrated in FIG. 1, a conventional client-server system for online ecommerce websites, with many complex and costly applications and servers, supported with a client-server system 100 that contains client-side applications 150 hosted by a customer web server 152, order tracking web server 154, and payment/refund web server 156, as well as server-side applications 160 hosted by a product application server 162, transaction application server 164, and fulfillment/inventory application server 166, where respective databases reside in enterprise data storage systems 170, while providing internet web services 140 including social media system with shopping carts, messaging services, and chat bots through HTTP Internet 130 to support client apps in web browsers on mobile devices 110, and host seller apps via web portals on laptops 120. Additionally, the Verge's 2020 report (NYC, NY) on Meta's plan to integrate shopping within chat highlights the limitations of conventional client-server systems for evolving ecommerce needs.

Client-server systems with messaging add-ons are a costly and complex solution for independent business owners managing multiple niche stores. These sellers need user-friendly apps to create, publish, and promote in-app stores, while communicating updates directly with customers on their smartphones. Also, customers who prefer a unified shopping experience often find online shopping frustrating by having to switch between applications for online orders, in-store pickups, and email notifications. Innovative apps are need to address these issues by providing an integrated platform to enable customers to browse products in stores, track orders, and message sellers within a single app, and sellers to easily scale from a small-format in-app store to multi-store shopping systems with robust order tracking and sales analytics.

Messaging apps are rapidly replacing phone calls, emails, and social media interactions. Millions of mobile users seek privacy, data encryption, and enhanced productivity offered by native messaging apps, a stark contrast to security concerns surrounding mobile shopping websites. Integrating customer and seller ecommerce apps with a messaging app can be challenging. These challenges include: facilitating status updates between customers and sellers through messages, which requires overcoming limitations imposed by messaging apps, such as the message size limit (e.g., 10 MB for iMessage and 160 characters for SMS), and synchronizing order histories across multiple devices owned by each customer. However, it is achievable, particularly when the ecommerce app itself is built as an extension app on a native messaging platform. This approach allows the ecommerce extension app to focus on adding comprehensive functionalities for customers and sellers, while secure communications between apps is efficiently handled by the messaging app. A 2023 NRF sales survey found that businesses lose an average of $13.70 for every $100 in accepted returns due to high online return rates and fraud losses. To address these issues, cost-effective and fraud-resistant methods are needed. This system streamlines return-refund processing by using temporary tables with security business rules to catch invalid requests and efficiently performing one-time data model cache updates only when return-refund workflows are completed. It eliminates both resource-intensive rollbacks common in client-server systems and the feasibility problems associated with customer-to-customer returns processes.

The present disclosure unveils a new ecommerce messaging system, which differentiates itself from traditional ecommerce websites built on the conventional client-server architecture by enabling customers to opt-in as subscribers for the messaging host to push in-app stores to their devices with the advantage to work with live data through propagation of dynamic updates among interconnected shopping UIs, and have data integrity and privacy safeguarded by the ecommerce extension app and the messaging app. In contrast, client-server systems require customers to request data from servers on the network impacted by high traffic volume and personal data security concerns. Additionally, the system empowers sellers to easily grow their business, from small stores on one device to multi-store shopping systems by distributing multiple stores to storefront devices based on a store-as-a-service model. Therefore, sellers can expand their reach to a wider customer base by simply adding more storefront devices or more multi-store shopping systems, and leverage built-in comprehensive multi-store sales analytics to gain insights to improve store performance through targeting. This approach stands in contrast to conventional client-server systems, which often requires additional software and infrastructure for scaling and linking information between databases together. There is a need to provide ecommerce extension apps that are focused on consolidating ecommerce functionalities inside a native messaging app that customers and sellers rely on.

### SUMMARY

As smartphones and tablets continue to expand storage capacities and computing power as well as improve gesture recognition and memory management, users seek powerful mobile applications, especially the ones integrated with popular messaging apps that go beyond the current offerings like ApplePay (Apple), WhatsApp Business (Meta), sticker apps, in-app purchases, Messages for Business (Apple) with URLs and authentication, and sharing content between a messaging app and extension apps on the same or different devices through IPC (interprocess communication). For sales-conscious sellers and tech savvy customers, apps that integrates full ecommerce functionalities into a native messaging app right on their own smartphones and tablets are convenient and secure alternatives to online retail websites with security concerns.

The present disclosure of the ecommerce messaging system (the system) addresses the complexity of traditional ecommerce websites with in-app stores powered with order workflow processing simplified by APIs (Application Programing Interfaces), products and promotions customized for specific audiences, and branded messages with URLs and attachments communicated via a messaging app. Furthermore, the system comprises two or more extension apps working in conjunction with the messaging host. Each extension app includes a core component (the core) that manages a set of smart services shared by two session apps built on distinct entity data models. The system empowers sellers to build small-format stores with products targeted to specific audiences or user groups, create and schedule promotions to increase sales, gain insights in sales analytics to customize promotions and product collections, and reach more customers by adding more storefront devices. Additionally, the system fulfills customer demand for convenience with seamless navigation across interconnected shopping UIs through propagation of dynamic updates, and tracking orders in sorted histories and message transcripts, within the secure and private environment of their own smartphone and tablets. Meanwhile, the core leverages native messaging integration to create an ecommerce communication platform. This platform facilitates efficient order workflow and in-app store updates between customer and seller session apps through branded messages with URLs encoded and decoded by tap-to-message and tap-to-update processes as one of the important system foundations. Additionally, the platform supports one-on-one, one-to-many, and role-based communications with branded messages, categorized by action keys for efficient entity data retrieval and update as well as business rule processing by respective smart service APIs, and transmitted between session apps via the messaging host. This innovative approach offers a significant advantage over traditional ecommerce websites with mass marketing strategy, which rely on complex client-server systems and treat messaging as a secondary feature.

In one embodiment related to interactions among system components, the session apps are constructed on distinct entity data models while sharing the same group and store entity objects, enabling customers to browse, order and track personal order histories in the first session app, and sellers to customize store collections and promotions, track order histories by user groups and then by customers, and evaluate sales across stores in the second session app. Also, both session apps share a set of smart services to process common functions through seamless inter-callability managed by the core to support propagation of dynamic updates in first session app, and URLs encoded and decoded through respective tap-to-message and tap-to-update processes, for instance. Additionally, the core sends API calls to a messaging host for transmitting branded messages, and pushing multi-media attachments or text files to message transcripts shared by customers and sellers on devices used by the same user group. Furthermore, this ecommerce communication platform is modular and scalable for configuring multi-store shopping systems on sellers' multiple devices through second session apps based on a store-as-a-service model, and synchronizing order workflow data between session apps across customers' multiple devices to make ecommerce easy for everyone in messaging.

In one embodiment related to alternating session apps, the system incorporates two session apps within one ecommerce extension app, enabling sharing the same app key assigned to the extension app by running one session app at a time on different client devices. This approach overcomes the messaging app's constraint of one app key per extension app that prevents customers and sellers from sharing messages for updating order workflows and in-app stores. Furthermore, users can be sellers for one set of in-app stores and customers for another set of in-app stores on the same device, identified by unique user groups.

In one embodiment related to two session apps with distinct entity data models designed to support the functionalities specific to sellers and customers. For example, a first (customer) session app facilitates shopping, placing orders, making payments through services, and tracking personal order histories, while a second (seller) session app empowers sellers to create and publish in-app stores with promotions, track order histories for all customers, configure multi-store shopping systems, and evaluate sales analytics. In another embodiment, the first and second session apps share a similar data structure to efficiently generate two varieties of order histories and launch the same store for editing or shopping.

In one embodiment related to propagating dynamic updates, the first session app initializes memory objects with items merged from the shopping cart and search results to present and store user gestures and edits in the active UI, applies business rules to memory objects for computing prices that are updated into the first session data model cache, invokes a session app API to update memory objects and refresh the current user interface, and propagates dynamic updates to memory objects associated with the shopping list, order list, checkout, and dynamic checkout widget UIs in the active store, triggering an automatic refresh these interconnected UIs. This propagation approach eliminates the need to rebuild memory objects from scratch, as it leverages existing shopping, search, and photo data already stored in local memory objects. It also conserves resources by performing price computations only when necessary. In contrast, customers can place orders at a client system but conventional client-server systems send and process the orders at a server system, which demand lot more data processing resources to extract and compute shopping cart, search selection, and photo data.

In one embodiment related to data integrity for in-app stores created by a single-device seller, the seller can access working copies of in-app stores to make changes that can be saved to the designated cache within a second session app, with the option to test promotions with production copies in another set of caches with read-only access. When a seller taps the publish button for the current store working copy, a production copy is being published to a user group, and an intermediate copy is created for potential last-minute cancellations. If the transmission is successful, the intermediate copy is deleted. Furthermore, separating cache storage spaces and read/write privileges insulates store working copies from production copies, and enables side-by-side comparisons to select the best promotion methods and schedules while maintaining data integrity. Additionally, to guarantee consistent order history across each customer's devices, the system verifies store data, prices and promotion discounts and deals. It then synchronizes order details using group ID, store ID, order numbers, secure customer authentication, and device PINs for cross-referencing purchase orders and receipts. This method offers a more comprehensive approach compared to the typical in-app purchase method of matching derived device IDs on signed receipts with application vendor identifiers.

In one embodiment related to efficient order workflow processing, the system incorporates action-key-based computation to set up data for deep link views within tap-to-message and top-to-update processes in the following cases: (a) A first session app on the sending device invokes the process to compute split-shipment data that is then merged with specific order data in preparation for a unified order history at the ordered stage in a tap-to-message process, (b) An action-key based smart service API on the receiving device reconciles prices to compute an order-payment summary at the ordered stage in a tap-to-update process, and (c) The core on the sending device computes order-payment data for time-series data merge and sales analytics refresh at the paid stage in a tap-to-message process. By processing action-key-based computations at the record level, this approach eliminates the need for later data processing between databases, a common requirement in client-server systems.

In another embodiment related to transferring multimedia store files to respective devices used by a specific user group, the core coordinates a serialization process with a tap-to-message process in the second session app for the seller, and a deserialization process in the container app and a tap-to-update process in the first session app for customers. An in-app store entity data contains photos, metadata, promotions, business policies, store collections, and data model cache streams that easily exceeds the file transfer limit, such as 10 megabytes, imposed by the messaging app. The system enables the first session app to invoke the process to partition and serialize the store entity data into one or more multimedia attachment files for file transfer, and requests the core to perform a tap-to-message process to generate a branded store message, notify the messaging host to transmit the branded store message and push the attachments to transcripts on devices used by the current group. Furthermore, the messaging app requires the attachments to be deserialized in the container app in the operating system. Having customers copied the attachments from the messaging app, the container app calls a specific smart service API to deserialize the attachments, updates the store entity data streams in the first session data model cache, and moves product photos into the application sandbox. When customers tap the received message again, the core launches the first session app to the store homepage for in-app shopping. The system streamlines store setup directly on customer devices through tap-to-message and tap-to-update processes. This is achieved by handling serialization and deserialization at the file level. Additionally, the system prioritizes privacy and data integrity by safeguarding order histories, eliminating security concerns often associated with online shopping. The following sections detail the embodiment aspects for processing order and return workflows, publishing and subscribing to stores for in-app shopping, and configuring sellers' multiple devices for multi-store shopping systems.

One aspect of the embodiments related to one-on-one communication model, branded messages are processed between a customer and a seller of the same user group within order workflows for privacy. The process comprises a set of status updates between alternating session apps through branded messages, sent and received, in message transcripts on devices used by a customer and a seller, while the core performs tap-to-message processes to generate branded messages with URLs or tap-to-update processes to decode URLs and provide direct access to deep link views in another session apps for next action. In one embodiment, an order workflow starts at the ordered stage with a branded order-requested message that is generated and sent via a tap-to-message process, followed with a series of tap-to-update processes using the same action-key-based smart service API to update statuses through the invoiced, paid, shipped and delivered stages with efficiency and reliability. Furthermore, the tap-to-message and tap-to-update processes are further enhanced by integrating with action-key-based computations. This integration expands the system's functionality to include: price reconciliation, split-shipment computation, and time-series-based sales analytics.

In another embodiment, the core communicates with a messaging host using a method comprising: (a) in response to post processing of a tap-to-message process, the core sends an API command for the messaging host to display the image of a branded message or filename of an attachment in the message bar through the IPC framework, and when a user tapping the send button in a message bar, the messaging host transmits the branded message or push the attachment file over the network to message transcripts on devices used by the same group, and issues callbacks for the core on the sending device to call the session app to update the current order status in the entity data model cache; and (b) in response to a messaging host callback confirming a user tapping a received branded message, the core performs a tap-to-update process to decode and update data in the session data model cache and launch the respective session app opening to a deep link view containing computed data for further review or action. When the user taps the notify button (if available) in the deep link view, the core performs a tap-to-message process to reply with a branded message to the sender for the next status update in a workflow. Unlike methods that require customers to switch a separate Meta's WhatsApp chat to message sellers after finding products on Facebook Shop, the communication between the core and messaging host through API commands and callbacks enables seamless navigation between session apps and message transcripts.

In one or more embodiments related to processing and communicating status updates in an order workflow, a method for generating and sending a branded order-requested message by a customer and updating and replying with a branded payment-requested message by a seller, including reconciling prices and synchronizing reconciled order-payment data, comprises: (a) in response to a customer tapping the place-order button, a first session app invokes a cluster process to compute split-shipment data in preparation for an unified order history, assigns an action key to identify the class of communication, and requests the core to perform a tap-to-message process to generate and send a branded order-requested message with a URL encoded with the shopping cart data, timestamped order-requested status, action key, and split-shipment data to both message transcripts with callbacks for the core on the sending device to call the first session app to update the timestamped order-requested status in the first session data model cache; (b) in response to a seller tapping the received message in the message transcript, the active core receives a callback and performs a tap-to-update process, decoding data in the URL, calling an action-key based smart service API to finish processing the data in the URL, to extract prices and deals from the second session data model cache to compute a new order-payment summary, merge the reconciled order-payment data, timestamped order-requested status, and split-shipment data into the order history, update in the second session data model cache similarly, and assemble data for opening a deep link view, then the core resumes to launch the second session app that opens the payment-request view with the reconciled order-payment summary and explanations of price differences, allowing the seller to tap the notify button to generate and send the branded payment-requested message with a URL encoded with the timestamped payment-requested status and reconciled data via a tap-to-message process with callbacks for the core on the sending device to call the second session app to update the timestamped payment-requested status in the session data model cache; and (c) in response to the customer tapping the received message in the transcript, the active core performs a tap-to-update process to call the smart service API to replace the matching order-payment data in the order history and first session data model cache with the one decoded from the URL. Thus, reconciled order-payment data is synchronized between session apps when a seller taps the send button to transmit the branded payment-requested message to transcripts for a respective customer to tap the received message in a transcript to trigger a tap-to-update process for a specific order workflow within an in-app store.

As a proactive measure, a price reconciliation is computed to ensure the order-payment data is up to date even if a customer missed updating a branded store message. In contrast, a client-server system processes order status updates with many database queries requiring extensive amount of data transfer between a client app and a database server.

In one embodiment related to using temporary tables with assigned caches in respective session apps to store return-refund data for order-return-refund workflows, both first and second session data model caches can remain unchanged until workflows are completed and one-time updates in both data model caches have been processed. This approach eliminates the need for rollbacks if either party exits workflows before refunds are issued, and clears any temporary tables and assigned caches no longer needed to freed up device space. In another embodiment related to synchronizing reconciled return-refund data between session apps on the sending and receiving devices at the completion of a return-refund workflow, a method for a one-time update comprising: (a) in response to a customer tapping the received branded return-refunded message in the transcript on the first device, the active core receives a callback and performs a tap-to-update process to decode data from a URL into memory, invoke the evaluation process, call a specific action-key-based smart service API to check data integrity and privacy and finish processing the data in the URL, then the core resumes to save the table back to the assigned cache, initialize full screen mode, launch the first session app opening to the order history, and invoke the returns smart service to open the refund confirmation view for review; in response to the customer tapping the notify button, the core performs a tap-to-message process to create and send the branded refund-confirmed message encoded with the temporary table; (b) in response to the customer tapping the send button, the messaging host transmits the branded return-refunded message to transcripts on both devices, and the core on the sending device updates the order history, return-refund data, return-shipment table, and SKU table in the first session data model cache, opens the first session app to the order history UI to display the return shipment and return-refund summary, and then deletes the assigned cache to free up device storage space; and (c) in response to the seller tapping the received branded refund-confirmed message in the message transcript on the second device, the active core receives a callback confirmation, decodes the temporary table and metadata in the URL, calls a respective action-key-based smart service API to update the order history, return-refund data, return-shipment table, and SKU table in the second session data model cache, opens the second session app to the order history UI to display the return shipment and return-refund summary, and saves the temporary table as a journal entry for the audit trail, and then deletes the assigned cache to free up device storage space. Therefore, when a return-refund workflow progresses to the refund-confirmed step for a specific return-refund request, the data model caches of both first and second session apps are consistently updated through the same action-key-based API. In this system, session data model caches remain unchanged even if return-refund requests are not finished. This is in contrast to traditional client-server systems, where a single database stores transaction data. In those systems, if a return request for a specific order is cancelled or disqualified, the system would need to roll back the returns data to a previous version through intensive data processing, potentially affecting other data too.

One aspect of the embodiments related to one-to-many communication model, sellers can publish in-app stores to user groups via a tap-to-message process for members or customers to save the stores to their own devices via a tap-to-update process. The second session app automatically serializes multimedia store files into attachments to be transferred to message transcripts on devices used by the current group via the messaging host. As required by the messaging app, customers can copy the transferred attachment files to the container app for a specific smart service API to deserialize them to set up store entity data and photos ready to the first session app to retrieve and populate in the store UIs for shopping, ordering, and tracking purchases directly on their respective devices with security and privacy. In one embodiment, the serialize-deserialize process circumvents the file transfer limit of 10-megabyte size restriction imposed by messaging apps and facilitates the first session app to launch stores for in-app shopping. In another embodiment, the core activates the first session app to propagate dynamic updates to related memory objects in interconnected shopping list, order list, checkout, and dynamic checkout widget UIs in the active store, so that customers can work with consistent data as they update their shopping carts and search result selections, and navigate between these interconnected UIs.

In one or more embodiments for publishing and subscribing to an in-app store, a method for performing tap-to-message, tap-to-update, and serialize-deserialize processes comprises: (a) in response to a seller tapping the publish button in the editor UI, a second session app invokes the process to partition and serialize store files over 10 megabytes into attachment documents, and requests the core to perform a tap-to-message process by staging collection placeholder parameters and the action key that identifies the communication class in memory to set up a URL, and calling respective smart service APIs to encode the staged data into the URL and overlay with a dynamically computed branding image to generate a branded store message, then the core notifies the messaging host to transmit the message to transcripts on devices used by the current group with callbacks, and push the attachments with sequential IDs at each tap of the send button, and then saves the timestamped attachment files and group ID in second session data model cache; (b) in response to a customer tapping the received store message in the transcript on the first device, the active core receives a callback and performs a tap-to-update process, decoding data in the URL, invoking the evaluation process to examine the context for first session app launch preparations, calling a respective action-key-based smart service API to finish processing the data in the URL and update collection placeholder parameters in the first session data model cache, and then the core resumes to launch the first session app opening the default store view with preset photos and metadata; (c) in response to the attachments copied over by the customer or subscriber from the messaging app to the container app, a specific smart service API deserializes the attachments, updates the store entity data streams in the first session data model cache, and moves product photos into the application sandbox; and (d) in response to the customer tapping the message in the transcript again, the core launches the first session app that opens to the store homepage for browsing product collections, and navigating between interconnected store UIs with photos, metadata, promotions, business policies, store collections, and data model cache streams for in-app shopping and order tracking. Furthermore, customers can conveniently open the stores located on their own devices for shopping, placing orders, and tracking histories for smoother user experience, and better security and privacy than online shopping with delivery tracking through emails and messages.

One aspect of the embodiments related to configuring a multi-store shopping system on a seller's multiple devices, a second session app uses unique device PINs to appoint the seller on the first-registered device to act as the distributors and for sellers on their respective storefront devices to act as publishers. Consequently, the second session app can customize the UIs, by role and device categories, for the distributor to create working copies and distribute production copies of assigned stores to publishers for read-only access, and for authorized publishers to include custom promotions in production copies that will be published as read-only production copies to subscribed user groups for shopping across stores and processing order workflows with respective publishers, all based on a store-as-a-service model through tap-to-message and tap-to-update processes. This approach safeguards data integrity by clear user role separation between the distributor and publishers, and by unique PINs used to ensure the device holding the store working copies with read and write access and production copies in different caches is the first registered device, and the ones holding the production copies with read-only access and custom promotions with full access are the storefront devices. The method to configure a multi-store shopping system comprises: (a) in response to the distributor tapping the assign button in the store manager view on the first-registered device, the core generates and sends a branded assignment-list message to a group of publishers; in response to a callback confirming a publisher tapping the received message, the core updates the list of stores assigned to registered devices in the second session data model cache on a respective storefront device to be used for planning; (b) in response to the distributor tapping the distribute button, the core generates and distributes a branded store message with serialized attachments to a group of publishers; and in response to each publisher tapping the received branded store message in the transcript, having the attachments copied to and deserialized in the container app, and tapping the message again, the core performs tap-to-update process, and then calls the first session app to launch the store UIs for read-only review; (c) in response to a publisher tapping the subscribe button in the group manager view, the core generates and sends a subscription list of reviewed stores subscribed by user groups created on the current storefront device to the distributor, who can then tap the received message to trigger the core to update the subscription list in the second session data model cache, verify the list with store review statuses, and tap the notify button to reply to the publisher with a branded approved message via a tap-to-message process; and (d) in response to the publisher tapping the received message, the second session app activates the promotion manager, publish button, order history, and sales analytics UIs for stores on the subscription list, and the respective publisher can create the promotion methods and event calendars customized by user groups, and publish the production copies with respective promotions to respective user groups; and (e) in response to the publisher tapping the publish button, the core generates and sends a branded store message with serialized attachments to the subscribed user group; in response to each subscriber tapping the received branded store message in the transcript, having the attachments copied to and deserialized in the container app to set up store entity data and photos ready for the first session app to access, and tapping the message again, the core performs a tap-to-update process, and then launch the first session app that opens to the store homepage for shopping and tracking with respective publishers.

In one embodiment, a multi-store shopping system provides efficient scalability. Unlike conventional client-server systems that require additional software and infrastructure for scaling and linking databases, this system leverages a common JSON data interface and efficient entity data access to accommodate more user groups on storefront devices. Subsequently, sellers can increase their reach to customers two ways: by adding storefront devices to the existing multi-shopping system, and by adding more multi-shopping systems for different brands.

The methods and systems described herein can be implemented by data processing systems, such as one or more smartphones, tablet computers, and other data processing systems and other consumer electronic devices. The methods and systems described herein can also be implemented by one or more data processing systems which execute executable computer program instructions, stored in one or more non-transitory computer readable media that cause the one or more data processing systems to perform the one or more methods described herein when the program instructions are executed. Thus, the embodiments described herein can include methods, data processing systems, and non-transitory computer readable media.

The above summary does not include an exhaustive list of all embodiments in this disclosure. All systems and methods can be practiced from all suitable combinations of the various aspects and embodiments summarized above, and also those disclosed in the Detailed Description below.

### BRIEF DESCRIPTION OF THE DRAWINGS

The present invention is illustrated by way of example and not limitation in the figures of the accompanying drawings. For a better understanding of the various described embodiments, reference should be made to the Detailed Descriptions, in conjunction with the following drawings, in which like reference numerals refer to corresponding parts throughout the figures.

FIG. 1 is a block diagram illustrating a conventional client-server system for online ecommerce websites;

FIG. 2 is a schematic diagram illustrating an ecommerce messaging system to update statuses between first and second session apps through branded messages communicated via a messaging app in accordance with one or more embodiments;

FIG. 3 is a block diagram illustrating a method for launching and switching between two session apps in an ecommerce extension app on a client device in accordance with one or more embodiments;

FIG. 4A is a block diagram illustrating methods for generating, sending, receiving, and updating branded messages to place an order, request a payment, and make a payment within order workflows in accordance with one or more embodiments;

FIGS. 4B-4C are block diagrams illustrating methods for generating, sending, receiving, and updating branded messages to confirm payments and deliveries within order workflows in accordance with one or more embodiments;

FIG. 5A is a flow diagram illustrating a method for publishing an in-app store through a branded store message to which a user group subscribes and serialized attachments with example user interfaces in accordance with one or more embodiments;

FIG. 5B is a flow diagram illustrating a method for subscribers to launch an in-app store for shopping by tapping received branded store messages in transcripts and have attachments deserialized with example user interfaces in accordance with one or more embodiments;

FIG. 6 is a flow diagram illustrating methods for processing a branded order-requested message for a seller and a branded payment-requested message for a customer including reconciliation and synchronization with example user interfaces in accordance with one or more embodiments;

FIG. 7 is a block diagram illustrating methods for tapping received branded messages to trigger tap-to-update processes and directly access deep link views for action in accordance with one or more embodiments;

FIG. 8A is a block diagram illustrating a method for using a specific returns smart service to detect the order phase of an order-return request for accessing a respective deep link view in accordance with one or more embodiments;

FIG. 8B is a block diagram illustrating methods for updating return-refund workflows with temporary tables and assigned caches until one-time updates in data model caches can be performed in accordance with one or more embodiments;

FIG. 9 is a flow diagram illustrating a method for configuring a multi-store shopping system on a seller's multiple devices through the distributor's assignment list and publishers' subscription lists in accordance with one or more embodiments;

FIG. 10A is a schematic diagram illustrating an ecommerce messaging system explained through an order workflow for status updates at the ordered and invoiced stages in accordance with one or more embodiments.

FIG. 10B is a schematic diagram illustrating an ecommerce messaging system explained through a return-refund workflow at specific steps in accordance with one or more embodiments.

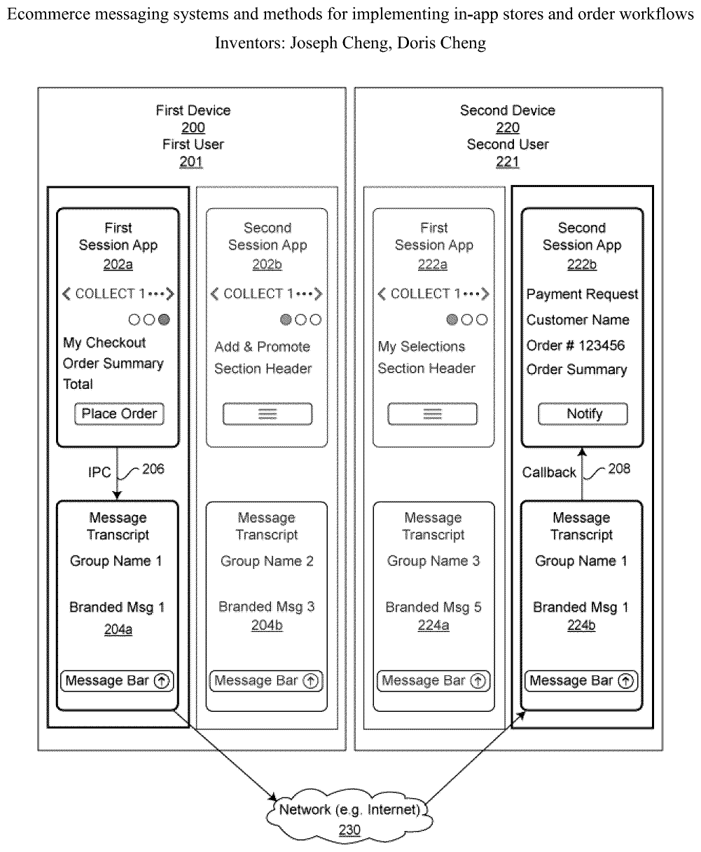

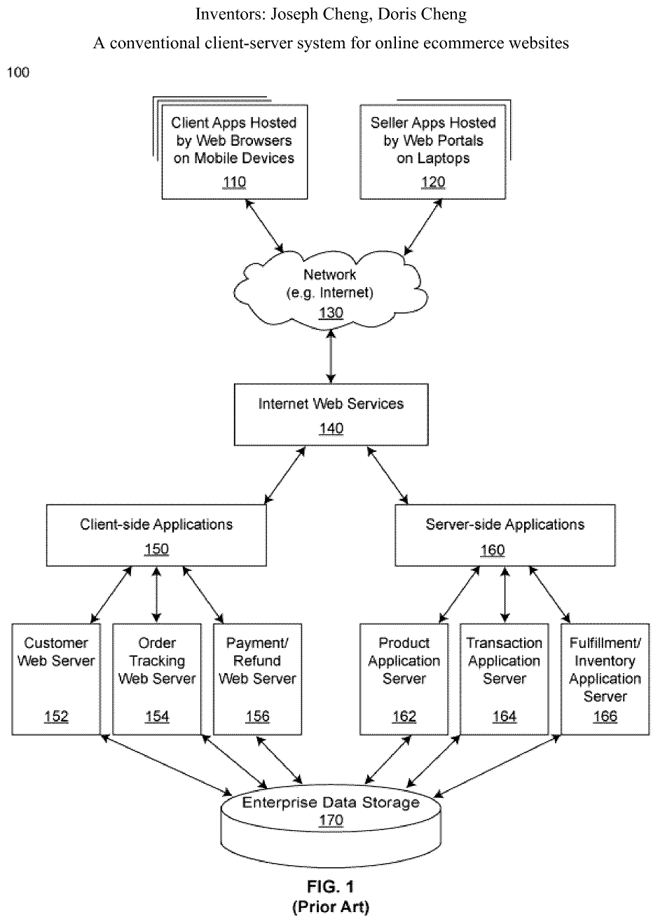

The drawings are not necessarily to scale, or inclusive of all elements of a system, emphasis instead generally being placed upon illustrating the concepts, structures, and techniques sought to be protected herein.

### DETAILED DESCRIPTION

Various embodiments and aspects will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments.

Reference in the specification to “one embodiment” or “an embodiment” means that a particular feature, structure, or characteristic described in conjunction with the embodiment can be included in at least one embodiment. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

The growing sophistication of smartphones and tablets in storage, processing power, gesture recognition, and memory management paves the way for building robust ecommerce functionalities as extensions within secure mobile messaging platforms. The ecommerce messaging system disclosed herein empowers the core in an extension app to manage session apps and smart services to efficiently process order workflows, in-app store publications and subscriptions, and multi-store shopping and tracking. Specifically, the core on the sending devices is enabled to route user gestures from the operating system to the active session apps, perform tap-to-message processes to generate branded messages, send the messages to transcripts on devices used by the same user group via a messaging host for recipients to tap the messages with callbacks; then the core on the receiving devices perform tap-to-update processes to update data in another session apps, and provide direct access to respective deep link views for review or reply to respective senders via tap-to-message processes. This generate-send-receive-update process for facilitating ecommerce between session apps through branded messages that can be communicated via a messaging host is one of the most efficient foundations of the system. Additionally, session apps are built on distinct entity data models while sharing the same store and group entities and the same set of smart services that are inter-callable on a flat architecture through a common protocol using a JSON data interface and easy entity data retrieval and update, enabling dynamic update propagation between interconnected UIs in the first session app, and managing in-app stores in production and working copies with data integrity in the second session app. Thus, the system can differentiate itself from conventional client-server systems by providing on-device session apps that can communicate data in URLs through branded messages via a secure messaging host.

In one embodiment related to alternating session apps and branded messages, the system enables a first session app on the first device launched by a first user to share the same app key alternately with a second session app launched by a second user on the second device. This innovative approach allows two or more session app users to converse with branded messages transmitted via a messaging host to message transcripts on participating devices used by the same user group for updating statuses in order workflows, publishing and subscribing to in-app stores, and implementing multi-store shopping. Furthermore, the system safeguards data integrity and privacy for accessing branded messages with appropriate use of group ID, store ID, device PINs, order numbers, customer authentication, and security business rules to ensure only intended users can view and interact with the appropriate branded messages across registered devices.

In one embodiment related to efficiency, session apps categorize data processing using action keys. This method enables the core to accurately trigger the designated smart service APIs to update changes in session data model caches during processing order workflows, publishing and subscribing to in-app stores, and configuring multi-store shopping systems on sellers' devices. In another embodiment, the extension app incorporates action-key-based computation and serialize-deserialize processes in tap-to-message or tap-to-update processes to set up data for deep link views and expand the system's functionalities, including a first session app invoking a cluster process to compute split-shipment data that is merged with specific order data in preparation of a unified order history when the place-order button is tapped, an action-key based smart service reconciling prices to be synchronized between session data model caches when a received branded order-submitted message is tapped, and the core computing order-payment data to merge time-series data and refresh sales analytics when a branded payment-received message is sent. In another embodiment, managing order-return workflows with temporary tables for transaction updates offer flexibilities in applying business rules to detect and prevent returns fraud, and to update both session data model caches only at the completion of return-refund workflows, eliminating costly rollback operations often associated with conventional client-server systems.

In another embodiment related to publishing and subscribing to in-app stores, when a seller taps the publish button for the active store created in the editor, the second session app sets up a set of multimedia store files and invokes the process to partition and serialize these files into attachments for file transfer during a tap-to-message process, solving the file transfer limit imposed by the messaging app. When a customer taps the received message to save the store to the current device, the core performs a tap-to-update process to open a preset store UI. After the customer has the attachment copied to and deserialized by a specific smart service API in the container app, and then taps the message again, the core performs another tap-to-update process to launch the first session app that can retrieve and populate deserialized data to open the store homepage for making shopping lists and placing orders. By having in-app stores on customers' devices, the user experience is smoother through propagation of dynamic updates between interconnected shopping UIs with security and privacy safeguarded by the messaging app and extension app. Unlike traditional ecommerce websites process customer requests and retrieve responses from database servers back and forth through the internet with security concerns.

In another embodiment related to configuring multi-store shopping systems, second session apps using a store-as-a-service model for the distributor to distribute production copies of in-app stores created on the first-registered device to publishers on storefront devices for read-only review, authorize qualified publishers to include custom promotions in production copies that will be published to subscribed user groups created on their respective storefront devices, and manage order workflows and store updates, enabling subscribers belonging to multiple user groups to subscribe to and shop across multiple stores and track orders with respective publishers. Furthermore, working copies and production copies are stored in separate caches to safeguard data integrity.

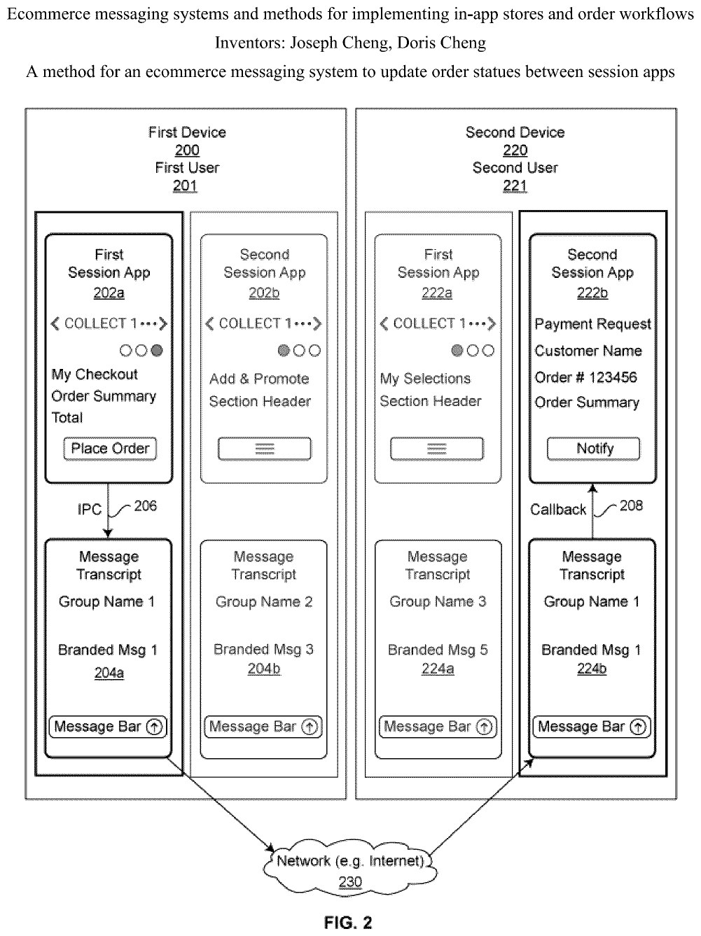

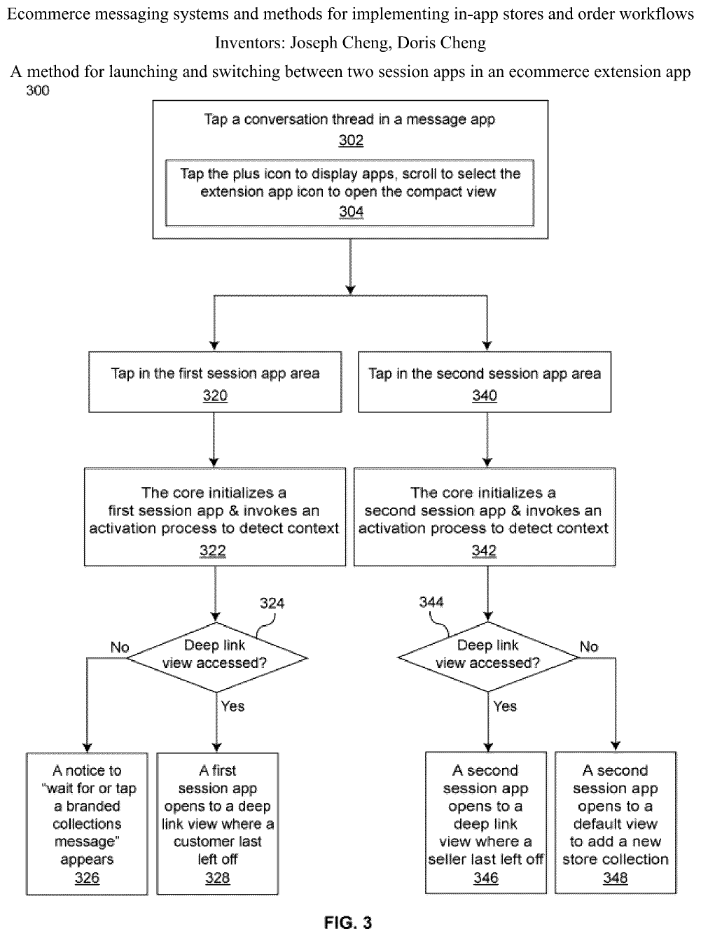

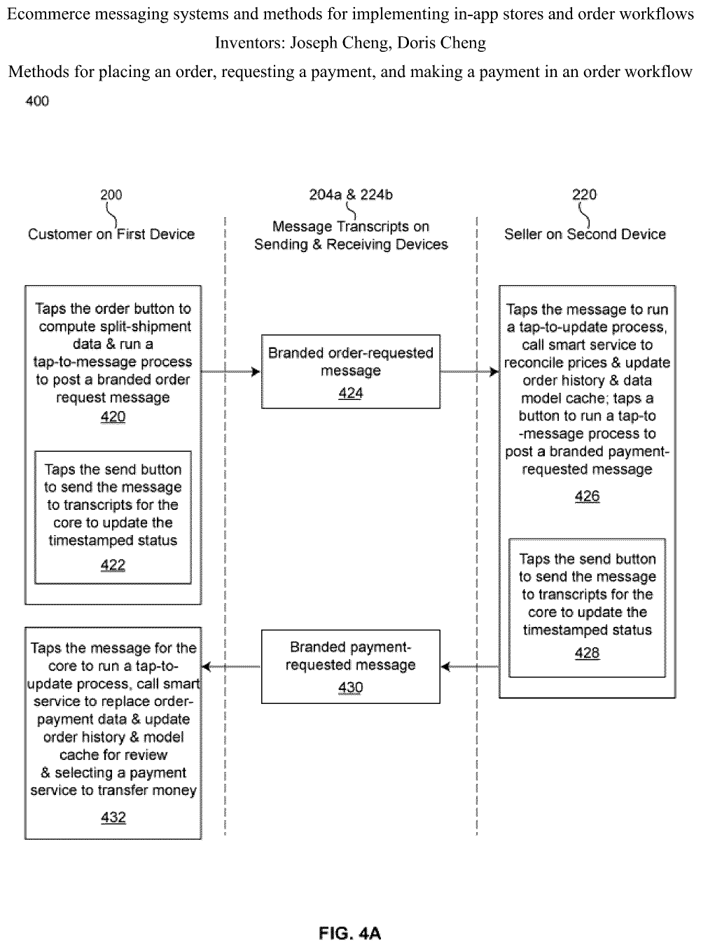

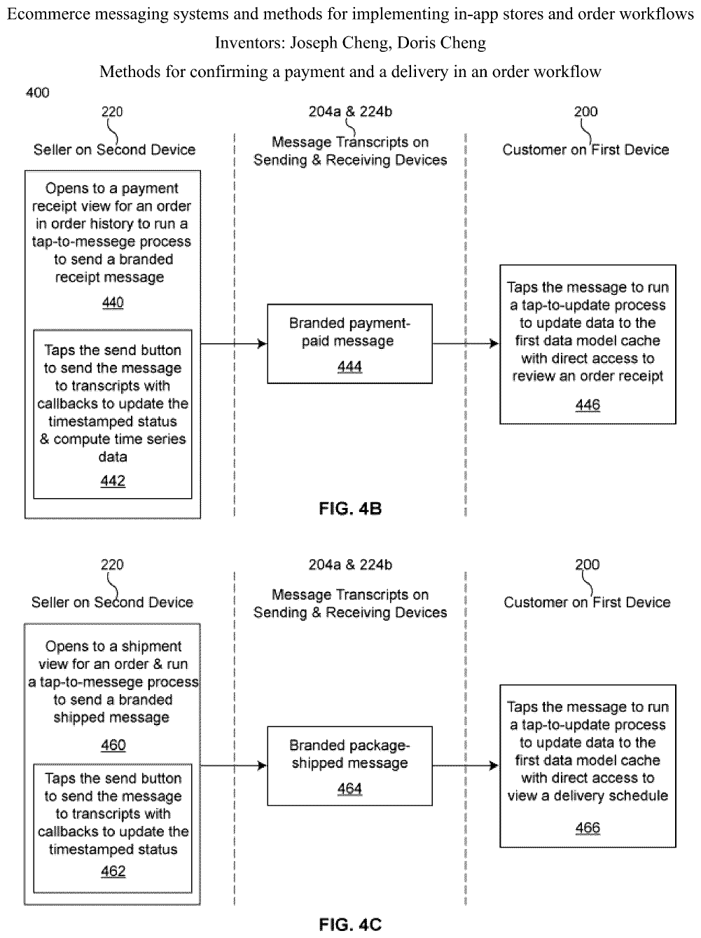

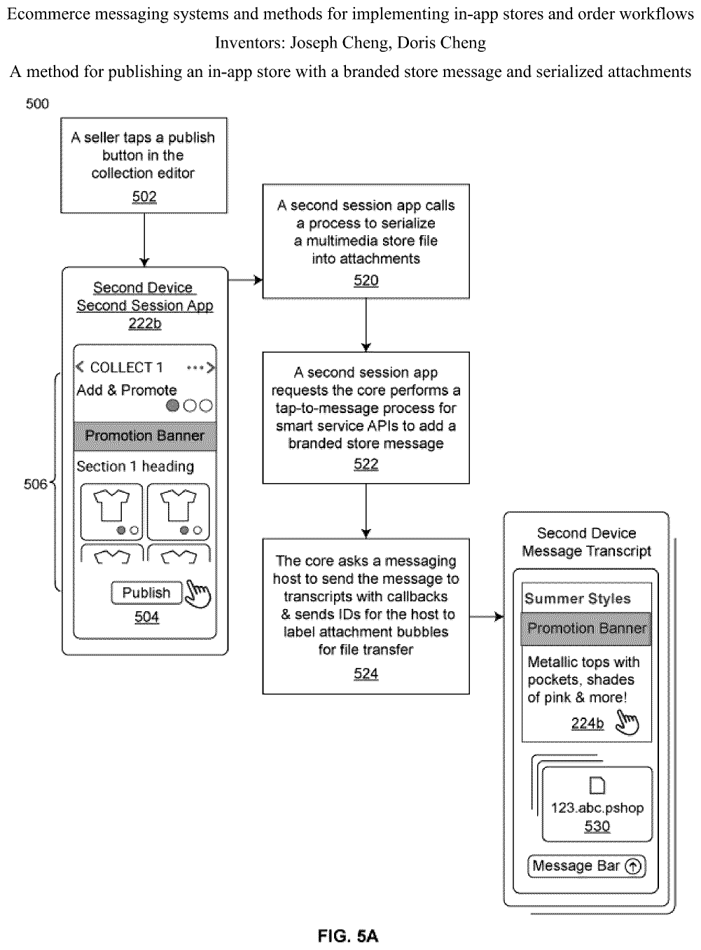

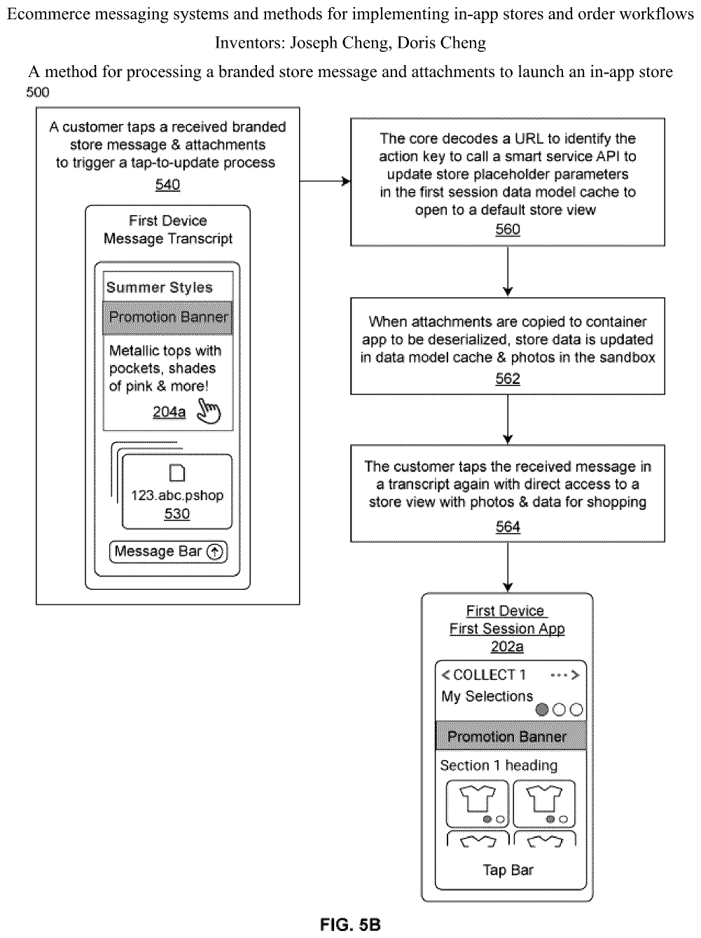

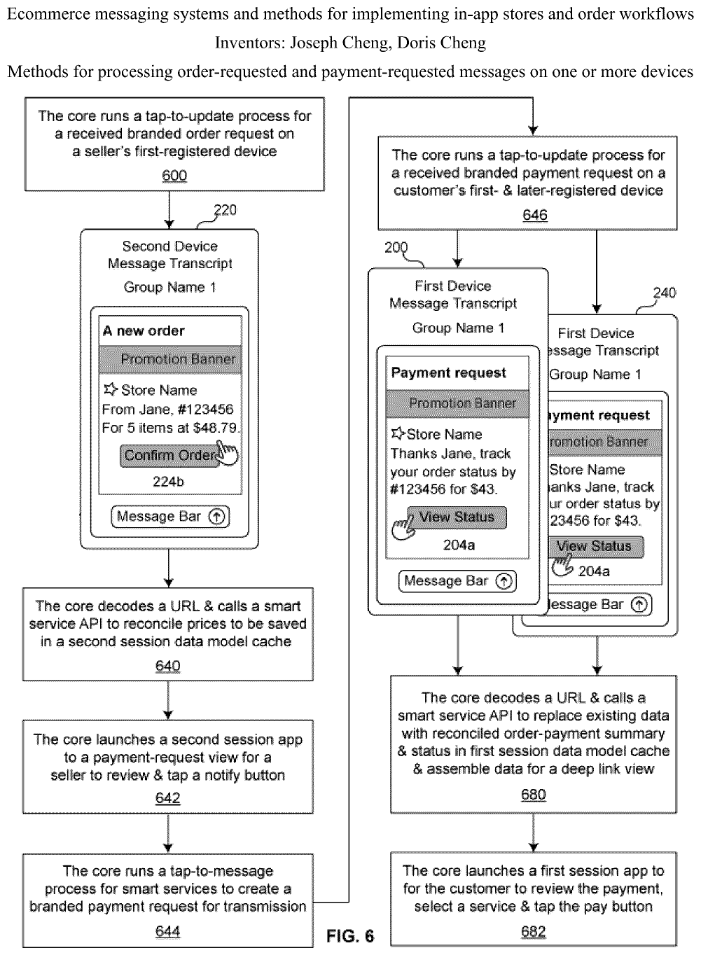

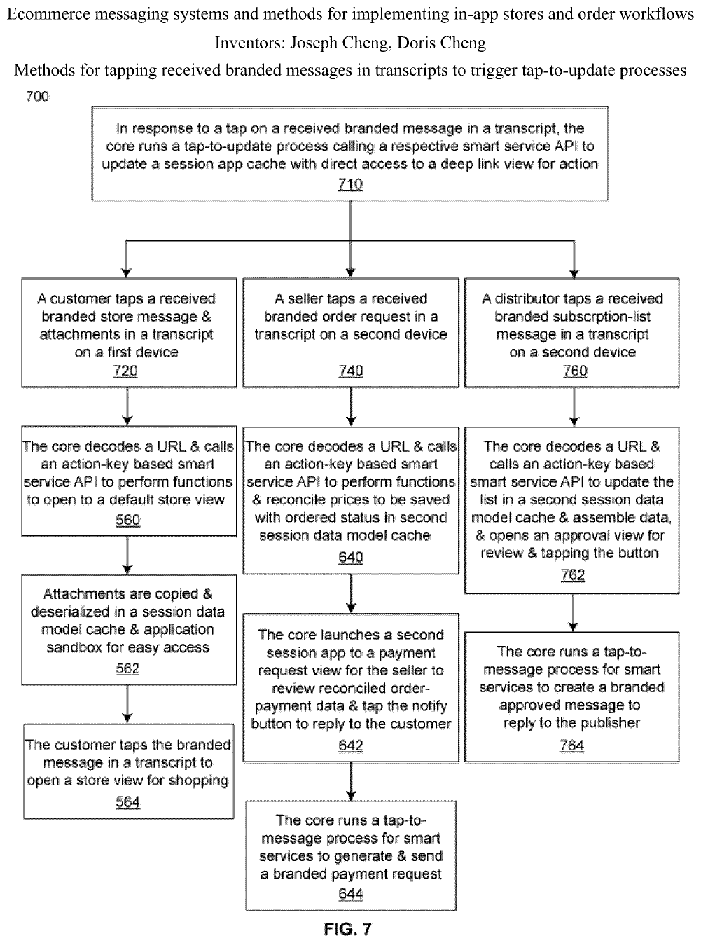

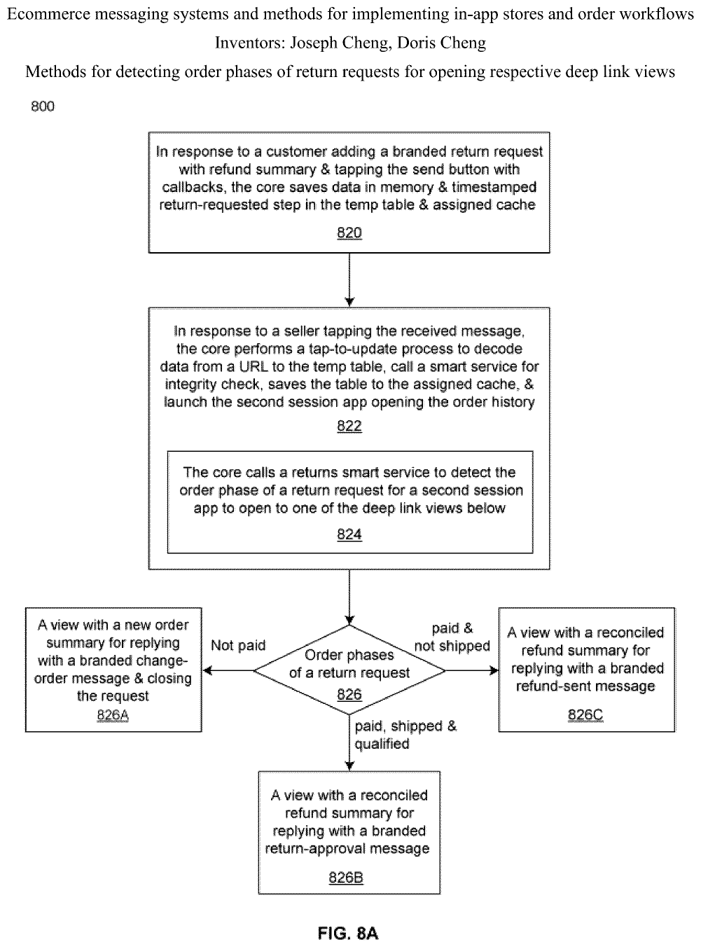

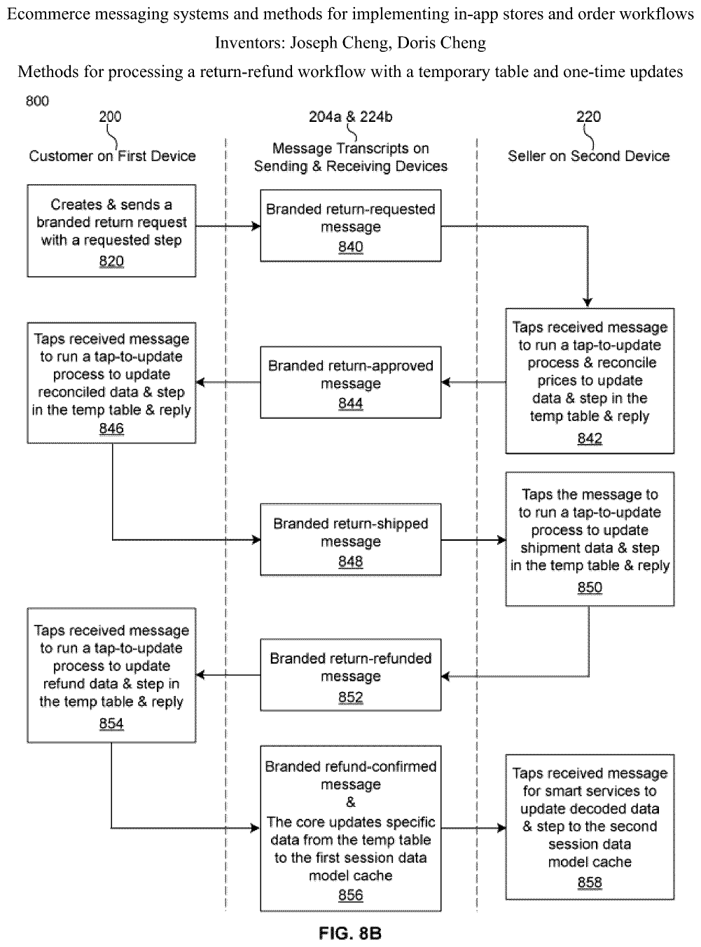

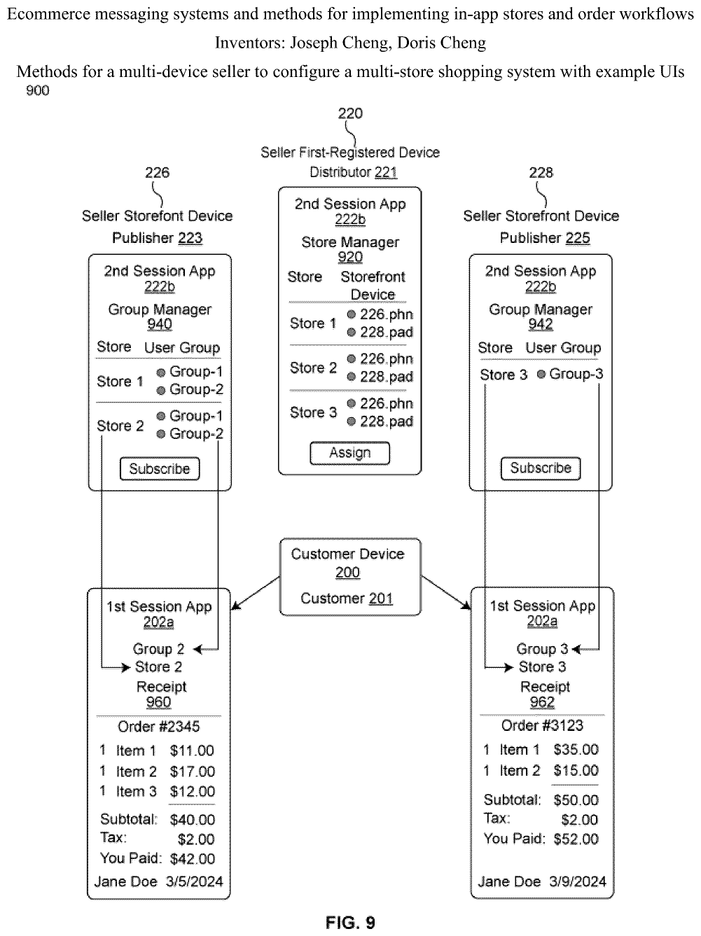

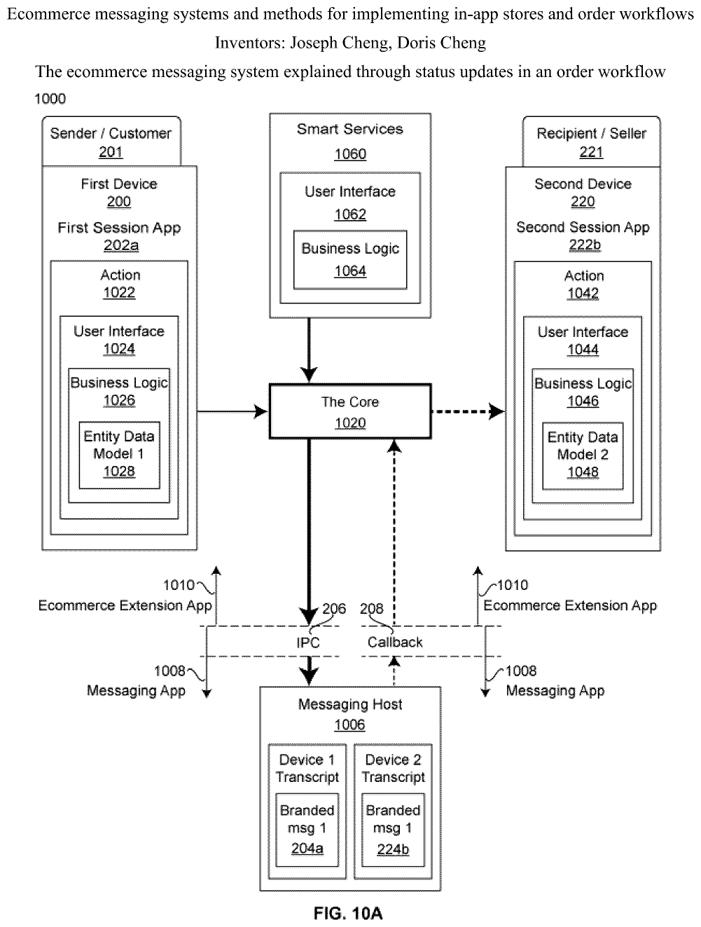

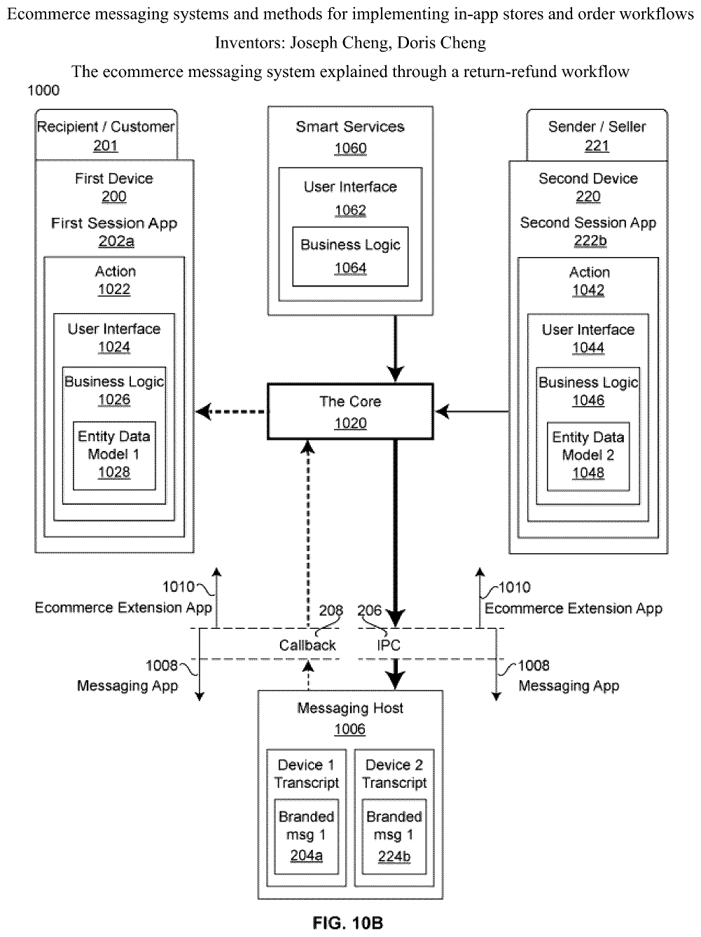

The following sections delve into the operation details outlined below with respective diagrams: FIG. 2 for status updates between a first and second session apps on respective devices in a ecommerce messaging system, FIG. 3 for launch alternating session apps within an ecommerce extension app, FIGS. 4A, 4B-4C, 8A, and 8B for using a one-on-one communication model to process order workflows, FIGS. 5A-5B for using a one-to-many communication model to publish and subscribe to in-app stores, FIG. 6 for updating statuses and synchronizing order data through tap-to-update processes, FIG. 7 for tapping received messages to trigger tap-to-update processes for further action in deep link views, FIG. 9 for configuring multi-store shopping systems using role-based communications, FIG. 10A for the system explained through an order workflow and status updates from the ordered stage to the invoiced stage, and FIG. 10B for the system explained through a return-refund workflow and updates from the return-requested step to the return-approved step.

According to one aspect of the embodiments described herein relates to processing order workflows between a customer and a seller within the ecommerce messaging system. An order workflow starts when a customer places an order, which triggers the first session app to request the core to perform a tap-to-message process to generate branded messages in one session app, and notifies the messaging host to send branded messages to message transcripts on participating devices. When a respective seller taps the received message in the transcript, the core performs a tap-to-update process to update data through a specific smart service API and launch another session app that opens a deep link view specific to the next action in the workflow. Furthermore, the system leverages the same smart service API to update remaining order statuses in respective tap-to-update processes within the same order workflow. In a one-on-one communication model, the system enables the core to manage session apps and smart services for generating branded messages on the sending device via a tap-to-message process, communicate with the messaging host for sending and receiving branded messages in message transcripts on both devices within the same group or thread, and then update order data and status in another session app on the receiving device via a tap-to-update process. This method is explained in FIG. 2 through an order workflow example for a customer sending an order request and a respective seller replying with a payment request below.

FIG. 2 is a schematic diagram illustrating an ecommerce messaging system to update statuses between first and second session apps through branded messages communicated via a messaging app in accordance with one or more embodiments. In one embodiment related to processing status updates in an order workflow, the system enables a first user 201 or customer on the first device 200 to use a first session app 202a to tap an action key to trigger the core to perform a tap-to-message process to generate a branded message encoded with a URL, request the messaging host to post the message to the message bar through an IPC (interprocess communication) 206 and transmit it to both message transcripts, 204a and 224b, through the internet 230 with callbacks for the core on the sending device to update the timestamped order status in the first session data model cache, and then a second user 221 or seller on the second device 220 taps the received branded message 224b in the transcript, and the core receives a callback 208 and performs a tap-to-update process to decode the URL, call a specific smart service API to perform functions and update data in the session data model cache, and launch a second session app 222b that opens a deep link view specific to the next action in the workflow for reply to the customer via a tap-to-message process.

In one implementation of one-on-one communication model for starting an order workflow at the ordered stage and progressing to the invoiced stage, a method for a first user to tap an action button in the first session app to generate and send a branded order-requested message via a tap-to-message process integrated with an action-key-based computation, and a second user to tap the received message in a transcript to have the core perform a tap-to-update process integrated with price reconciliation for accessing to a deep link view displaying the reconciled order-payment summary for further action comprises: (a) in response to a first user 201 tapping the place-order button in the checkout UI on the first device 200, a first session app 202a invokes a cluster process to compute split-shipment data that is then merged with specific order data in preparation of a unified order history, assigns an action key to identify the class of communication, and requests the core to perform a tap-to-message process to copy and stage shopping cart data, split-shipment data, the timestamped ordered status, and action key to set up a URL, call action-key-based smart service APIs to encode the staged data into a URL and overlay with a dynamically computed branding image to create a branded order-requested message, and then the core sends an API command to a messaging host to post the branded order-requested message and the send button in a message bar through an IPC 206; (b) in response to a first user tapping the send button, the messaging host transmits the message to message transcripts, 204a and 224b, on the respective first and second devices, 200 and 220, over the Internet 230 with callbacks for the core on the sending device to call the first session app to update the timestamped order-requested status in the entity data model cache; and (d) in response to a seller 221 tapping the received branded order-requested message in the transcript on the second device 220, the active core receives a callback 208 and performs a tap-to-update process, decoding data in the URL, invoking the evaluation process to examine the context for second session app launch preparations, calling a respective action-key-based smart service API to extract prices and deals from the second session data model cache to compute a new order-payment summary, merge the reconciled order-payment data and timestamped order-requested status into the order history, update the data and status in the second session data model cache, and assemble data required for opening a deep link view, then the core resumes to initialize full-screen mode, and launch the second session app that opens the payment-request view with the reconciled order-payment summary and explanations of price differences; upon the seller tapping the notify button, the core performs a tap-to-message process to generate the branded payment-requested message to be transmitted to message transcripts with callbacks for the core on the sending device calls the second session app to update the timestamped payment-requested status in the entity data model cache. Subsequently, the reconciled order-payment data will be synchronized in order histories between session apps when the customer taps the received branded payment-requested message in the transcript to trigger a tap-to-update process.

Referring to FIG. 2, when the first device is running a first session app 202a as illustrated in the example, a second session app 202b on the same device is deactivated because there is a limit of one app key per extension app. Similarly, when the second device is running a second session app 222b, a first session app 222a on the same device is deactivated. Additionally, the FIG. 2 illustration shows that deactivated session apps 202b and 222a are listed with different user groups, so that branded messages 204b and 224a appearing in message transcripts are different.

According to one aspect of the embodiments described herein relates to launching and switching between two session apps that shares the same app key assigned to an ecommerce extension app by the messaging app, as illustrated in 300. When the extension app of the disclosure has been installed on a mobile device with the native messaging app enabled, a user opens the messaging app to a particular user group or thread, select a conversation to display the launch bar, scroll to tap the extension app icon for the messaging app to display the compact view, and then tap one of the two distinct touch-sensitive areas to launch a first session app to resume to the last accessed view for in-app shopping or placing orders with sellers using the second session app on respective devices, or a second session app to open to the editor for generating a new in-app store or resume to the last accessed store view for creating or publishing the store to a user group using the first session app on respective devices, monitoring order histories, or evaluating sales analytics on the current device. The details on launching extension session apps are described and explained below.

FIG. 3 is a block diagram illustrating a method for launching and switching between two session apps in an ecommerce extension app on a client device in accordance with one or more embodiments. After launching a messaging app, a user locates a specific group thread and tap one of the conversations to activate the messaging host in step 302. Then, the user taps the plus icon preceding the message bar to display the vertical launch bar, scrolls to tap the extension app's application icon to open a compact view in step 304. When the compact view displays two touch sensitive areas labeled for respective session apps, the user can tap anywhere inside one of the two areas for the core to bring up the corresponding deep link view as explained below.

Referring to FIG. 3, in response to a selection of a first-session-app area in step 320, the core initializes a first session app, requests the operating system for full-screen mode in preparation of launching and displaying a first session app on top of the screen regions where the message transcript and the compact view were, and invokes an activation process to verify the user role as a group member or manager, and identify the name and data source of a deep link view where a user last left off in the first session app in operation 322. If the activation process detects that the user is a group member in operation 322, it verifies any user activities in a first session app in step 324 and then requests the first session app to perform one of the following tasks: (a) displaying a notification to wait for a new branded store message or to tap an existing message in a message transcript if no access to a deep link view has been found in the first session data model cache in operation 326; or (b) opening a deep link view where a first user last left off if the deep link view and data source have been found in the first session data model cache in operation 328. Thus, launching a first session app from a compact view is convenient for a customer to quickly return to the last accessed deep link view if there is at least one received branded store message in the transcript for the current user group to which the user belongs.

Referring to FIG. 3, in response to a selection of a second-session-app area in step 340, the core initializes a second session app, requests the operating system for full-screen mode in preparation of launching and displaying the second session app on top of the screen regions where the message transcript and the compact view were, and invokes an activation process to verify a user role as a group member or manager, and identify the name and data source of a deep link view where the user last left off in a second session app in operation 342. If the user is a group manager as detected in operation 342, the activation process verifies any user activities in a second session app in step 344 and then requests the second session app to perform one of the following tasks: (a) opening a deep link view where a second user last left off if the deep link view and data source have been found in the second session data model cache in operation 346, or (b) opening the editor view to add new collections and promotions if no access to a deep link view has been found in the second session data model cache in operation 348. Furthermore, if the user is not yet a group manager, the core opens the group manager view for adding a new user group or selecting an existing group from the list. Thus, launching a second session app from a compact view is easy for a seller to quickly return to the last accessed deep view for the next action or the editor to create a new in-app store with collections and promotions.

According to one aspect of the embodiments described herein relates to processing sets of status updates within order workflows, as illustrated in 400. In one embodiment, an order workflow starts at the ordered stage with a branded order-requested message that is generated and sent via a tap-to-message process, followed with a series of tap-to-update processes using the same action-key-based smart service API to update statuses through the invoiced, paid, shipped and delivered stages with efficiency and reliability. In another embodiment, the system enables the core to notify the messaging host to transmit branded messages between customer and seller session apps through transcripts sharing the same app key, and respond to messaging host callbacks when users tap the send button in a message bar or a received branded message within a transcript. This facilitates smooth navigation between session apps and message transcripts. Additionally, the core calls respective smart service APIs to perform action-key-based computations to set up data for deep link views, including: reconciling order-payment prices in a tap-to-update process when a seller taps a received branded order-requested message in a transcript, setting up split-shipment data in a tap-to-message process when a customer taps the place-order button, and calculating order-payment data as time-series data in a tap-to-message process when a seller taps the send button for transmitting a branded payment-received message.

To start shopping, recipients or customers need to save in-app stores sent by a respective seller to their devices. By tapping received branded store messages in transcripts, customers can trigger a tap-to-update process to open default store views with preset photos and data in a first session app. When customers have copied the attachment files to the container app in the operating system, a specific smart service is called to deserialize the files, update the store entity data streams in the first session data model cache, and move product photos into the application sandbox. Upon returning to the message transcript, customers can tap the message again, and then the core performs another tap-to-update process to launch the first session app to open the store homepage with photos, metadata, promotions, and data model streams for making shopping lists and placing orders.

To start ordering products, a customer needs to tap on the place-order button in the checkout view to start an order workflow for the current purchase. Then, the first session app invokes a cluster process, assigns an action key, and requests the core to perform a tap-to-message process to generate and send an order-requested message to a respective seller, who can then tap the received message in the message transcript, enabling the core to perform a tap-to-update process to decode the URL, reconcile prices that can be updated with the order-requested status in the second session data model cache and present a deep link view for further action. When the seller tapping the notify button in the view to reply to the customer, the core generates a branded payment-requested message encoded with the payment-requested status via a tap-to-message process, and notifies the messaging host to transmit the message to the customer. Thus, an order workflow, from placing an order to delivery, typically begins with a customer's request through a tap-to-message process. This is followed by tap-to-update processing, which may also involve an action button allowing the customer to reply directly through another tap-to-message interaction. This cycle repeats until all packages in the order are delivered. The order workflow processing through a one-on-one communication model is further explained and described by FIG. 4A, FIG. 4B, and FIG. 4C below.

FIG. 4A is a block diagram illustrating methods for generating, sending, receiving, and updating branded messages to place an order, request a payment, and make a payment within an order workflow in accordance with one or more embodiments. In one embodiment related to placing an order, a method for a customer tapping the place-order button to trigger a first session app to compute split-shipment data, assign an action key, and request the core to perform a tap-to-message process to generate a branded order-requested message to be transmitted to message transcripts 204a and 224b is explained by operations 420 and 422: (a) in response to a customer tapping the place-order button in the checkout view with an order summary, a first session app invokes the cluster process to compute split-shipment data that is then merged with specific order data in preparation for a unified order history, assign an action key to identify the class of communication, and requests the core to perform a tap-to-message process to copy and stage shopping cart data, split-shipment data, the timestamped ordered status, and action key in memory for a URL, call action-key-based smart service APIs to encode the staged data into the URL and overlay with a dynamically computed branding image to create a branded order-requested message, and then the core sends an API command to a messaging host to post the branded order-requested message and the send button in a message bar through an IPC on the sending device 200 in operation 420; and (b) in response to a customer tapping the send button with callbacks confirming the message has been transmitted to message transcripts 204a and 224b, the core on the sending device calls the first session app to updates the timestamped order-requested status in the entity data model cache in operation 422. If a user cancels a send action at the last minute, the user can choose to update, start over, or leave the shopping cart as is.

In another embodiment related to requesting payment, a method for a seller tapping the received branded order-requested message to trigger the core to perform a tap-to-update process with price reconciliation and direct access to a deep link view specific to the next status update in the workflow for the seller to reply with a branded payment-requested message is explained by operations 424, 426 and 428: (a) in response to a seller tapping the received branded order-requested message in the transcript on the second device 220 in step 424, the active core receives a callback and performs a tap-to-update process, decoding data in the URL, invoking the evaluation process to examine the context for second session app launch preparations, calling a respective action-key-based smart service API to finish processing the data in the URL, extract prices and deals from the second session data model cache to compute a new order-payment summary, merge the timestamped order-requested status, reconciled order data, and split-shipment data into the order history, update the status and data in the second session data model cache, and assemble the required data for a subsequent the deep link view, then the core resumes to initialize full-screen mode, and launch the second session app to open the payment-request view with the reconciled order-payment summary and explanations of price differences in operation 426; and (b) in response to the seller tapping the notify button, the core performs a tap-to-message process by copying and staging reconciled order-payment data and a timestamped payment-requested status in memory for a URL, calling respective smart service APIs to encode the staged data into the URL and overlay with a dynamically computed branding image for creating a branded payment-requested message, enabling the core to send an API command to a messaging host to post the message to a message bar through an IPC, also in operation 426; and (c) in response to a seller tapping the send button, the messaging host transmits the message to transcripts 204a and 224b on both devices 220 and 200 with callbacks, and the core on the sending device calls the second session app to update the timestamped payment-requested status in the entity data model cache in step 428.

In one embodiment related to making payment, a method for a customer tapping the received branded payment-requested message in the transcript for the core to perform a tap-to-update process to replace the respective order-payment data and update the status to ensure data synchronization and allow the customer to review reconciled order-payment summary and then tap the pay button to select a payment service to transfer payment to the seller is explained by operations 430, and 432: (a) in response to a customer tapping the received branded payment-requested message in the transcript on the first device 200 in step 430, the active core receives a callback and performs a tap-to-update process, decoding the data in a URL, invoking the evaluation process to examine the context for first session app launch preparations, calling a respective action-key-based smart service API to finish processing the data in the URL, replace the matching order-payment data in the order history and first session data model cache with the one decoded from the URL including the timestamped payment-requested status, so that both session data model caches are synchronized with respect to the reconciled order-payment data for a specific order, and assemble the require data for a subsequent deep link view, then the core resumes to initialize full-screen mode, and launch the second session app that opens the payment-request view with the reconciled order-payment summary, explanations of price differences, and notify button in operation 432; and (b) in response to a customer tapping the notify button, a payment services view opens for a customer to select a native money transfer service or a third party website to send money to the seller also in operation 432. If a customer chooses to pay for the order later, the order remains at the invoiced stage in the order history until a respective seller replies with a branded payment-received message.

FIGS. 4B-4C are block diagrams illustrating methods for generating, sending, receiving, and updating branded messages to confirm payment and delivery within an order workflow in accordance with one or more embodiments. When a payment made by a specific customer has been posted to the transaction history in a notification, the seller can verify the transaction and send a receipt to confirm the payment with the customer. In one embodiment related to sending a payment receipt, a seller launches the order history to a specific customer and order number, and then taps the paid button to open the payment-receipt view for sending the customer with a branded payment-receipt message. Additionally, the core converts order transaction data into time series components by time periods and incrementally update the time series to refresh sales analytics on the seller device. When the delivery schedule and tracking numbers for a specific customer, order number and package identifier have been confirmed, the seller can send a delivery confirmation message. In one embodiment related to package delivery, a seller launches the order history for a specific customer, order number, and package ID, and then taps the shipped button to open the delivery schedule view to send a branded package-shipped message with shipment information to the respective customer. The respective implementation details are explained below.

Having verified a respective payment by a specific customer, a seller can access the relevant order history by either tapping a related branded message in a message transcript or launching a second session app from a compact view, scroll to the respective customer section, tap the corresponding paid button. When the payment receipt view opens, the seller can review the payment summary and send a branded payment-received message to the customer. Meanwhile, the core automatically converts order transaction data into time-series components categorized by specific time periods whenever an order workflow has progressed to the paid stage. The method for sending a payment receipt to a customer and refreshing sales analytics for a seller at the paid stage is explained by operations 440, 442, 444, and 446: (a) in response to a seller tapping the paid button in the order history for a specific customer and order number, a payment-receipt view opens with transaction details for review in operation 440; (b) in response to the seller tapping the notify button in the view, a second session app requests the core to perform a tap-to-message process to stage payment-transaction data and the timestamped payment-received status in memory to set up a URL, call respective smart service APIs to encode the staged data into the URL and overlay with a dynamically computed branding image to generate a branded payment-received message, enabling the core to send an API command to a messaging host to post the message to a message bar through an IPC also in operation 440; (c) in response to the seller tapping the send button, the messaging host transmits the message to transcripts 204a and 224b on both devices 200 and 220 with callbacks; and upon receiving the callback, the core on the sending device calls the second session app to update the timestamped payment-received status in the entity data model cache, and then converts order transaction data into time series components by time periods and incrementally update the time series to refresh sales analytics on the seller device 220, in operation 442; and (d) in response to the customer tapping the received branded message in the transcript 204a on the first device 200 in step 444, the active core receives a callback and performs a tap-to-update process, decoding the data in the URL, invoking the evaluation process to examine the context for first session app launch preparations, calling a respective action-key-based smart service API to finish processing the data in the URL, merge the timestamped payment-received status into the order history, update the status in the first session data model cache, and assemble the required data for a subsequent the deep link view, then the core resumes to initialize full-screen mode, and launch the first session app to the deep link view for a customer to review a payment summary receipt in operation 446.

When a specific order has been packed and shipped with a tracking number and delivery schedule regarding a carrier or a curbside pickup, a seller can launch the relevant order history by either tapping a related branded message in a message transcript or launching a second session app from a compact view, find the customer section, and tap the shipped button for the core to generate and send a branded package-shipped message for a respective customer to review the delivery summary with a method explained by operations 460, 462, 464 and 466: (a) in response to a seller tapping the shipped button in an order history to open a package delivery view for a specific customer, order number and package, a seller reviews shipping details and adds the order tracking number and the delivery schedule for a package in transit by a delivery or curbside service in operation 460; (b) in response to the seller tapping the notify button in the package delivery view, the core performs a tap-to-message process by copying and staging delivery data and a timestamped package-shipped status in memory for a URL, calling respective smart service APIs to encode the staged data into the URL and overlay with a dynamically computed branding image for creating a branded package-shipped message, enabling the core to send an API command to a messaging host to post the message to a message bar through an IPC also in operation 460; (c) in response to the seller tapping the send button for the branded package-shipped message, the messaging host transmits the message to transcripts 204a and 224b on both devices 200 and 220 with callbacks; and upon receiving the callback, the core on the sending device calls the second session app to update the timestamped package-shipped status in the entity data model cache in operation 462; (d) repeating steps a, b and c if the order is delivered in multiple packages; and (e) in response to the customer tapping the received branded package-shipped message in the transcript 204a on the first device 200 in step 464, the active core performs a tap-to-update process in operation 466, decoding the data in the URL, invoking the evaluation process to examine the context for first session app launch preparations, calling a respective action-key-based smart service API to finish processing the data in the URL, merge the shipment data and timestamped shipped status into the order history, update the data and status in the first session data model cache, and assemble the required data for a subsequent the deep link view, then the core resumes to initialize full-screen mode, and launch the first session app to the delivery schedule view for a customer to review the delivery method, tracking number, and estimated time of arrival, without having to go back and forth between emails and online ecommerce websites.

According to one aspect of the embodiments described herein relates to how in-app stores are published and subscribed through tap-to-message and tap-to-update processes working in conjunction with serialize-deserialize processes, as illustrated in 500. In one embodiment, in response to a seller tapping the publish button, a second session app invokes the process to partition and serialize multimedia store files into attachments to be transferred to message transcripts, and requests the core to perform a tap-to-message process to generate and send a branded store message to message transcripts on devices used by the current user group via a messaging host. In another embodiment, in response to a recipient tapping a received branded store message in a transcript, the core receives a callback and performs a tap-to-update process to directly present a default store view with preset data and photos. When a recipient has copied the attachment files from the messaging app to the container app in the operating system, the app calls a specific smart service API to deserialize the attachments, updates the store entity data streams in the first session data model cache, and moves product photos into the application sandbox, enabling the core to launch the first session app to store UIs populated with data for shopping and tracking orders. Therefore, the serialize-deserialize process is a practical solution to the file size limit imposed by the messaging app for file transfer over the network. By launching the first session app, customers can conveniently open the stores located on their own devices for shopping, placing orders, and tracking histories with dynamic updates propagated between store UIs for smoother user experience, better security and privacy.

Prior to publishing an in-app store, sellers can use the editor to create or import product collections, test promotion methods and schedules for intended user groups, and then tap the publish button for the active store to generate and send branded store messages and serialized attachments to respective user groups via a tap-to-message process. The recipients who opt in as subscribers can tap received store messages in transcripts to trigger a tap-to-update process, copy the store attachments to be deserialized in the container app and updated in the first session data model cache, tap the message again for accessing the in-app store on respective devices with data retrieved and populated for making shopping lists and placing orders. The implementation of a seller publishing an in-app store to a user group and a customer subscribing to the store for shopping with user examples are explained in detail as illustrated in FIG. 5A and FIG. 5B respectively.

FIG. 5A is a flow diagram illustrating a method for publishing an in-app store through a branded store message to which a user group subscribes and serialized attachments with example user interfaces in accordance with one or more embodiments. In one embodiment, a method for publishing a branded store message with serialized attachments to message transcripts on devices used by the same group via a tap-to-message process is explained by operations 502, 504, 506, 520, 522, and 524: (a) in response to a seller tapping the publish button 504 in the editor view 506 at step 502, a second session app 222b invokes the process to split and serialize the multimedia store files over 10 megabytes into a set of transmissible attachments in operation 520, assigns the action key, and requests the core to perform a tap-to-message process to stage the collection placeholder parameters and in-app store action key that identifies the communication class in memory to set up a URL, call action-key-based smart service APIs to encode the staged data into the URL and overlay with a dynamically computed branding image for creating a branded store message, enabling the core to send an API command to a messaging host to post the message and attachments to the message bar individually through an IPC, in operation 522; (b) in response to the seller tapping the send button for the message, the messaging host transmits the message to transcripts such as 224b on devices used by the same group, issues callbacks for the core on the sending device to get the first attachment ready for transmission; in response to the seller tapping the send button for transmitting the first attachment bubbles, such as attachment bubble 530, the messaging host pushes the attachment with a sequential ID to message transcripts; repeat the same step to push the remaining attachments; in response to the callbacks for the last attachment, the core saves the timestamped attachment files and group ID to second session data model cache in operation 524. To update promotion methods and schedules for the same store later, sellers can simply tap the publish button to generate and send the branded store messages to transcripts on devices used by the same group.

To copy attachment files in a message transcript to the container app as required by the messaging app, a subscriber or customer can take note of filenames in the attachment bubbles in the transcript, tap on a user group name or avatar on the top center of the transcript screen, scroll down to the document section, select an attachment filename as displayed in the transcript, and then tap the copy icon to copy the selected attachment into the container app in the operating system. Repeat the process for each remaining attachment. Subsequently, the container app calls a specific smart service API to deserializes the attachments, update the store entity data streams in the first session data model cache, and move product photos into the application sandbox, enabling the first session app to present the product photos, metadata, promotions, and data model cache streams in the store UIs for making shopping lists and tracking orders.

FIG. 5B is a flow diagram illustrating a method for subscribers to launch an in-app store for shopping by tapping received branded store messages in transcripts and have attachments deserialized with example user interfaces in accordance with one or more embodiments. In one embodiment, a method for a recipient to tap a received branded store message in a message transcript and directly access a default store in a first session app, and copy the attachments to be deserialized by a specific smart service API in the container app, and then tap the message again to access the store for in-app shopping is explained by operations 540, 560, 562, and 564: (a) in response to a subscriber or customer tapping a received branded store message in the transcript 204a on the first device, a messaging host issues a callback confirming the transmission of the message in operation 540; (b) in response to the callback, the active core performs a tap-to-update process, decoding data in the URL in the received branded message, invoking the evaluation process to examine the context for first session app launch preparations, calling a respective action-key-based smart service API to update collection placeholder parameters in the first session data model cache, then the core resumes to initialize full-screen mode and launch the first session app opening the default store view with preset photos and metadata in operation 560; (c) in response to a subscriber noting filenames in attachment bubbles, such as in 530, and copying them from the messaging app to the container app in the operating system, the app calls a specific smart service API to deserialize the attachments, update the store entity data streams in the first session data model cache, and move product photos into the application sandbox in operation 562; and (d) in response to an API command sent by the core to a messaging host, the container app returns the subscriber to the messaging transcript; in response to the subscriber tapping the same branded store message again, the core launches the first session app 202a to present the store homepage for making shopping lists, while photos, metadata, promotions, business policies, store collections, and data model cache streams are retrieved and populated in store UIs for in-app shopping, checking out, and order tracking in operation 564.

According to one aspect of the embodiments described herein relates to integrating price reconciliation into tap-to-update processes to synchronize reconciled order-payment data between two session data model caches within an order workflow. As an order workflow progresses from being placed at the ordered stage to being billed at the invoiced stage, an action-key-based smart service on a seller device can automatically recompute up-to-date order-payment data with up-to-date data stored in the second session data model cache for the core to reply to a respective customer with a branded payment-requested message, and then the action-key-based smart service on the customer device can replace the matching order-payment data in the order history and first session data model cache with the one decoded in the URL in a subsequent tap-to-update process. This proactive approach ensures customers have the latest information for payment, even if they miss store update messages accidentally. Additionally, both order histories for the specific order are updated with reconciled prices at the invoiced stage. To guarantee consistency of order-payment data and status updates across multiple devices signed in with the same registration email address for a specific order workflow, customers must tap the received branded payment-requested message, one by one on each receiving device, to activate a tap-to-update process to replace the existing order-payment data in the session model cache with the one decoded in the URL. Furthermore, to maintain data integrity, the system prevents any tap-to-update requests for the next status update until the payment-requested message for the same order workflow have been updated on all receiving devices. FIG. 6 illustrates the process of reconciling order-payment data in a tap-to-update process on a seller's first-registered device. This reconciled data, encoded within a URL, is then used to replace existing order-payment data on both the customer's first-registered device and any later-registered devices. This ensures synchronization of order-payment data across participating devices. The detailed operations are explained below.

FIG. 6 is a flow diagram illustrating methods for processing a branded order-requested message for a seller and a branded payment-requested message for a customer including reconciliation and synchronization with example user interfaces in accordance with one or more embodiments. In one embodiment, a method for a seller tapping the received branded order-requested message in the transcript to trigger the active core to perform a tap-to-update process, call a smart service API to reconcile prices, and reply with a branded payment-requested message encoded with reconciled data to a respective customer is explained by operations 600, 640, 642 and 644: (a) in response to a seller tapping the received branded order-requested message in the transcript 224b on the first-registered device 220, a messaging host issues callbacks to the core on respective devices in operation 600; (b) in response to the callback, the active core performs a tap-to-update process, decoding data in the URL, invoking the evaluation process to examine the context for second session app launch preparations, and calling a respective action-key-based smart service API to finish processing the data in the URL, extract prices and deals from the second session data model cache to compute a new order-payment summary, merge the timestamped order-requested status, reconciled order-payment data, and split-shipment data into the order history, update the status and data in the second session data model cache, and assemble the required data for a subsequent the deep link view in operation 640; (c) in response to a notification from the smart service, the core resumes to initialize full-screen mode, and launch the second session app that opens the payment request view with the reconciled order-payment summary, explanations of differences in operation 642; and (d) in response to the seller tapping the notify button in the payment-request view, the core performs a tap-to-message process to copy and stage reconciled order-payment data and payment-requested status in memory for a URL, call action-key-based smart service APIs to encode the staged data into the URL and overlay with a dynamically computed branding image for creating a branded payment-requested message, enabling the core to send an API command to a messaging host to post the message to a message bar through an IPC, also in operation 642; and (e) in response to a seller tapping the send button for the branded payment-requested message, the messaging host transmits the message to transcripts on participating devices with callbacks; and the core on the sending device calls the second session app to update the timestamped payment-requested status in the entity data model cache for a specific order in operation 644.

In one embodiment, a method for a customer tapping a received branded payment-requested message in the transcript with callbacks for the active core to perform a tap-to-update process to review reconciled order-payment summary and transfer money to a selected payment service is explained by operations 646, 680, and 682: (a) in response to a customer tapping the received branded payment-requested message in the transcript 204a on the first-registered device 200 for a messaging host to issue callbacks in operation 646; (b) in response to the callback on device 200, the active core performs a tap-to-update process, decoding data in the URL of the received branded message, invoking the evaluation process to examine the context for first session app launch preparations, and calling a respective action-key-based smart service API to finish processing the data in the URL, replace the existing order-payment data in the first session data model cache with the reconciled order-payment data decoded from the URL, merge a timestamped payment-requested status and data into the order history, update the status in the first session data model cache, and assemble the required data for the payment-request view, so that both session data model caches are synchronized with the latest order-payment information for the specific order to maintain data integrity even if the customer may have missed store update messages accidentally; (c) the customer is required to repeat the step (b) on the later-registered device 240, so that the reconciled order-payment data is synchronized between session data model caches on devices 220 and 240, where devices 200 and 240 registered by the same customer email address for the same order workflow, also in operation 680; and (d) in response to a notification from the smart service, the core resumes to initialize full screen mode and launch the first session app opening the payment-request view for the customer to review the reconciled order-payment summary and explanations of price differences, and tap the notify button to pop open the payment services view to select a native money transfer service or a third party website to send money to the seller on either device 200 or 240 in operation 682. Furthermore, customers are required to tap received payment-requested messages on all their receiving devices for the smart service to align order histories between session data model caches before proceeding to the next status update in the same order workflows; therefore, to view the latest update afterward, they only need to tap on the same branded message on any of their registered devices.

According to one aspect of the embodiments described herein relates to tap-to-update processes triggered by users' tapping received branded messages in message transcripts with direct access to respective deep link views for action as illustrated in 700. Additionally, session apps categorize branded messages with unique action keys, while assigning these action keys to smart service APIs. When a tap-to-update process is triggered by a user tapping a received branded message with a URL in a transcript, the core to decode the URL, identify the appropriate action-key-based smart service API, and call it to process the specific function required, ensuring consistent data processing within categories like order workflows, in-app store subscriptions, and multi-store shopping configurations, as described and explained below.

FIG. 7 is a block diagram illustrating methods for tapping received branded messages to trigger tap-to-update processes and directly access deep link views for action in accordance with one or more embodiments. When a recipient taps one of these three classes of branded messages received in a transcript, the active core receives a callback and performs a tap-to-update process to access a respective deep link view populated with data all set up by a respective action-key-based smart services API as outlined in step 710 with details described in three sections below.

One aspect of the embodiments described herein relates to group members who opt-in as subscribers to update branded store messages and have attachments deserialized for launching a first session app to respective in-app store UIs for making shopping lists and placing orders. By tapping received branded store messages in message transcripts, subscribers can directly access a default store view, and then copy the attachments to the container app by taking the steps to note the attachment file names in the transcripts, tap on a user group name or avatar on the top center of the screen, scroll down to the document section, select one of the attachments, and then tap the copy icon to copy the selected attachment into the container app in the operating system. Repeat the process for each remaining attachment. Subsequently, the container app calls a specific smart service API to deserialize the attachments, updates the store entity data streams in the first session data model cache, and moves product photos into the application sandbox, enabling each subscriber to tap the same message to launch the first session app to the store homepage with product photos, metadata, promotions, and data model cache streams retrieved and populated in the store UIs for shopping and tracking, as explained and described below.

In one embodiment, a method for a customer tapping a received branded store message with direct access to a respective in-app store for shopping via a tap-to-update process, which works alongside with a deserialization process, is explained by operations 720, 560, 562, and 564: (a) in response to a customer tapping the received branded store message encoded with a URL in step 720, the active core receives a callback confirmation from the messaging host and performs a tap-to-update process, decoding data in the URL, invoking the evaluation process to examine the context for first session app launch preparations, calling a respective action-key-based smart service API to update collection placeholder parameters in the first session data model cache, then the core resumes to initialize full screen mode, and launch the first session app opening the default store view with preset photos and data in operation 560; (b) in response to attachments copied over from the messaging app by the subscriber to the container app in the operating system, the app invokes a specific smart service API to deserialize the attachments, update the store entity data streams in the first session data model cache, and move product photos into the application sandbox in operation 562; and (c) in response to the subscriber tapping the received branded store message again, the core receives the callback and performs a tap-to-update process to launch the first session app 202a that opens the store homepage with photos, metadata, promotions, and data model cache stream retrieved and populated in store UIs for in-app shopping, placing orders, and tracking order histories in operation 564.

Another aspect of the embodiments described herein relates to tap-to-update processes integrated with price reconciliation. This integration ensures data synchronization and consistent status updates across all participating devices by updating reconciled order-payment data in data model caches between session apps when an order workflow progresses from the ordered stage to the invoiced stage. In one embodiment, a method includes reconciling prices at the ordered stage to merge reconciled order-payment data into the order history and update the session data model cache on the sending device, and then replacing the matching data with the reconciled order-payment data in the order history and session data model cache on the receiving device via a subsequent tap-to-update process in the workflow. Thus, reconciled order-payment data is synchronized between session apps when a seller taps the send button to transmit the branded payment-requested message to transcripts for a respective customer to tap the received message to trigger a tap-to-update process for a specific order workflow within an in-app store on each participating device registered with the same email address, as explained and described below.

In one embodiment, referring to FIG. 7, a method for a seller to tap a received branded order-requested message in the transcript to trigger a tap-to-update process, price reconciliation, and reply to a customer with a branded payment-requested message is explained by operations 740, 640, 642 and 644: (a) in response to a seller tapping the received branded order-requested message in the transcript on the second device in step 740, the active core receives a callback and performs a tap-to-update process, decoding data in the URL, invoking the evaluation process to examine the context for second session app launch preparations, calling a respective action-key-based smart service API to finish processing the data in the URL, extract prices and deals from the second session data model cache to compute a new order-payment summary, merge the timestamped order-requested status, reconciled order-payment data, and split-shipment data into the order history, update the status and data in the second session data model cache, and then assemble the required data for a subsequent the deep link view in operation 640; (b) in response to a notification from the smart service, the core resumes to initialize full-screen mode, and launch the second session app to open the payment-request view with the reconciled order-payment summary, explanations of price differences, and the notify button in operation 642; and (c) in response to a seller tapping the notify button, the core performs a tap-to-message process for copying and staging reconciled order-payment data and a payment-requested status in memory for a URL, calling action-key-based smart service APIs to encode the staged data into the URL and overlay with a dynamically computed branding image for generating a branded payment-requested message, and then the core sends an API command to a messaging host to post the message to a message bar through an IPC for the seller to tap the send button, enabling the messaging host to transmit the message to transcripts on both devices with callbacks; upon receiving the callback, the core on the sending device calls the second session app to update the timestamped payment-requested status in the entity data model cache for a specific order in operation 644. When a recipient taps the received branded payment-requested message in the transcript on the first device, the active core receives a callback and performs a tap-to-update process to decode data in the URL and replaces the existing one with the reconciled order-payment summary decoded from the URL. Consequently, reconciled order-payment data is synchronized between session apps when a seller taps the send button to transmit the branded payment-requested message to transcripts for a respective customer to tap the received message to trigger a tap-to-update process for a specific order workflow within an in-app store.

Another aspect of the embodiments described herein relates to configuring multi-store shopping systems. By utilizing the store-as-a service model, the second session app leverages the unique device PINs to configure multi-store shopping systems on sellers' multiple devices by appointing sellers on the first-registered devices to act as the distributors and for sellers on their respective storefront devices to act as publishers. Consequently, second session apps can customize the UIs to facilitate this role-based communication and enable the distributor to distribute production copies of assigned stores to a group of publishers with read-only access on respective storefront devices and grant approval to publishers with privileges to add custom promotions to production copies that will be published to subscribed user groups for multi-stores shopping. The tap-to-update process for the distributor of the system to grant publishers the privileges to promote and manage stores on the storefront devices, as illustrated in FIG. 7, is explained and described below.

In one embodiment, when the distributor taps a received branded subscription-list message to in a message transcript in step 760, the core receives a callback and performs a tap-to-update process, enabling the distributor to evaluate the list with store review statuses for authorizing the requesting publisher to add custom promotions by user groups to production copies that will be published to subscribed user groups for read-only access to the stores on the subscription list. This tap-to-update process followed with a reply to the publisher via a tap-to-message process is explained by operations 762 and 764: (a) in response to the distributor tapping the received branded subscription-list message in the transcript on the first-registered device, the active core receives a callback and performs a tap-to-update process, decoding data in the URL, invoking the evaluation process to examine the context for second session app launch preparations, calling a respective action-key-based smart service API to finish processing the data in the URL, update the subscription-list data in the second session data model cache, and assemble the required data for a subsequent the deep link view, then the core resumes to initialize full-screen mode, and launch the second session app opening to the deep link view, displaying the stores categorized by user groups on the subscription list and the store review statuses as the basis to authorize the publisher with more privileges in operation 762; and (b) in response to the distributor tapping the notify button in the view, the core performs a tap-to-message process to generate and send a branded approved message with a URL encoded with the approval data to both message transcripts via a tap-to-message process with callbacks for the core on the sending device to call the second session app to update the timestamped approved status in the entity data model cache on the first-registered device in operation 764. Subsequently, when the publisher taps the received message in the transcript, the active core receives a callback and performs a tap-to-update process, activating direct access to the approval-granted view for review and activation of promotion manager, publish button, order history, and sales analytics UIs. Then, the publisher can define promotion methods for testing and scheduling the campaigns targeted by user groups for respective stores in the promotion manager UIs. To publish the active store with custom promotions, a publisher can tap the publish button to have the session app serialize the store file into attachments and request the core to perform a tap-to-message process to generate and send a branded store message to message transcripts on devices used by the user group, and then transfer attachment files to transcripts at each tap of the send button, enabling subscribers to tap respective received messages to trigger a tap-to-update process, have the attachment files copied to and deserialized in the container app, and then tap the message again for launching the first session app to open the store homepage populated with data for in-app shopping.

According to one aspect of the embodiments described herein relates to processing an order-return workflow 800 by using a temporary table to store order-return data by order number in memory, two assigned caches to store the temporary table in respective session apps, and two session data model caches to be updated upon completion of the workflow. In one embodiment, a method for processing a customer's return-refund request comprises using a returns smart service to identify an action-key-based returns smart service API to determine the current phase of a return request, and then present a respective deep link view for further action: (a) if the order has not been paid, a change-order summary view appears for a respective seller to reply with a branded change-order message, (b) if the order has been paid, received, and qualified for a refund, a reconciled refund summary with return approval ID and shipment instructions appears for the seller to reply with a branded return-approved message, (c) if the order has been paid but not yet shipped, a reconciled refund summary view appears for the seller to reply with a branded refund-sent message after a payment is transferred. The details of processing a return request based on the order phase identified by a returns smart service are explained in FIG. 8A below.

FIG. 8A is a block diagram illustrating a method for using a specific returns smart service to detect the order phase of an order-return request for accessing a respective deep link view in accordance with one or more embodiments. In one embodiment, a method for a customer to create and send a branded return-requested message, and for a seller to tap the received message in the transcript to trigger a tap-to-update process, invoke a returns smart service to determine the current phase of a return request, and then reply with a respective branded message is explained by operations 820, 822, 824, 826, 826A, 826B and 826C: (a) in response to a customer tapping the returns button for a specific order number and a shipment package containing the items to be returned in the order history, a return request view opens for selecting items to be returned and identifying reasons for the change, allowing the customer tapping the notify button to trigger a tap-to-message process for the core to copy and stage return-requested data and return-refund summary into a temporary table in memory for a URL, call action-key-based smart service APIs to encode the staged data into the URL and overlay with a dynamically computed branding image to generate a branded return-requested message, and then send an API command to a messaging host to post the message in a message bar through an IPC; in response to a customer tapping the send button, the messaging host transmits the message to transcripts on both devices with callbacks, and the core on the sending device updates the data in memory and timestamped return-requested step into the temporary table in memory, and then saves the table back to the assigned cache in the first session app in operation 820; (b) in response to a seller tapping the received branded return-requested message in the transcript on the second device, the active core receives a callback and performs a tap-to-update process to decode data from a URL to the temporary table, invoke the evaluation process, call a specific action-key-based smart service API to check data integrity and privacy and finish processing the data in the URL, then the core resumes to save the table back to the assigned cache in the second session app, initialize full screen mode, and launch the second session app opening to the order history in operation 822; (c) the calls a returns smart service to determine the current phase of a return request in operation 824, and then open the respective deep link view in step 826; (d) if the order has not been paid, the core calls the returns smart service to compute the order summary reconciled with the items to be returned and presents the new order-payment summary in the change order view for review; in response to the seller taping the notify button, the core generates a branded change-order message via a tap-to-message process; in response to the seller tapping the send button, the messaging host transmits the message to message transcripts with callbacks for the core on the sending device to close the return request in operation 826A; (e) if the order has been shipped and the return request is qualified, the core calls the returns smart service to compute a refund summary reconciled with the items to be returned and present the reconciled refund summary with the return approval ID, return address, and shipment instructions in the return-refund view for the seller to review; in response to the seller tapping the notify button in the view, the core performs a tap-to-message process to generate a branded return-approved message; in response to the seller tapping the send button, the messaging host transmits the message to message transcripts with callbacks for the core on the sending device updates the data in memory and timestamped return-approved step into the temporary table, and then saves the table back to the assigned cache in operation 826B; and (f) if an order has been paid and not yet shipped, the core calls the returns smart service to open the return-refund payment view for review; in response to the seller tapping the notify button, the core performs a tap-to-message process to generate the branded refund-sent message; upon the seller tapping the send button, the messaging host transmits the message to message transcripts with callbacks for the core on the sending device updates the timestamped refund-sent step into the temporary table in memory, and then saves the table back to the assigned cache in operation 826C, and wherein the seller should have transferred the refund using a payment service as specified in the branded refund-sent message.

According to one aspect of the embodiments described herein relates to processing each return-refund workflow by using a temporary table to store return-refund data by order number in memory, two assigned caches to store the temporary table in respective session apps, and two session data model caches to be updated on the sending and receiving devices when the workflow is complete. In one embodiment, a temporary table is used to process return-refund data at the requested, approved, shipped, and refunded steps in a workflow until a one-time update of both session data model caches can be performed at the refund-confirmed step. Therefore, even if return-refund requests are cancelled or disqualified, this method ensures the first and second session data model caches remain unchanged. In contrast, a client-server system needs to rollback transaction updates to previous versions with intermediate file processing if either party exits the workflow before a refund is issued. Moreover, the order-return transaction updates are processed by the same action-key-based smart service API for efficiency and consistency, while the system can free up device storage by deleting both assigned caches no longer needed. Once the refund is confirmed, a one-time update synchronizes both session data model caches with the data in the temporary table. This finalizes the return-refund process and closes the return-refund request. Processing of order-return-refund workflows is explained and described in FIG. 8B below.

FIG. 8B is a block diagram illustrating methods for updating return-refund workflows with temporary tables and assigned caches until one-time updates in data model caches can be performed in accordance with one or more embodiments. In one embodiment, a method for a customer to generate and send a branded return-requested message and a respective seller to update and reply with a branded return-approved message, while the return-requested step is progressed to the approved step via a tap-to-update process, is explained by operations 820, 840, 842 and 844: (a) in response to the customer tapping the returns button for a specific order and package in the order history, the first session app requests the core to perform a tap-to-message process to copy and stage return-requested data and return-refund summary in memory for a URL, call action-key-based smart service APIs to encode the staged data into the URL and overlay with a dynamically computed branding image for creating a branded return-requested message to be posted to a message bar through an IPC in operation 820; (b) in response to the customer tapping the send button, the messaging host transmits the branded return-requested message to transcripts on both devices with callbacks, and the core on the sending device updates the data in memory and timestamped return-requested step into the temporary table, and then saves the table back to the assigned cache in the first session app in operation 840; (c) in response to a respective seller tapping the received branded return-requested message in the transcript on the second device, the active core receives a callback and performs a tap-to-update process to decode data from a URL to the temporary table, invoke the evaluation process, call a specific action-key-based smart service API to check data integrity and privacy and finish processing the data in the URL, then the core resumes to save the table back to the assigned cache in the second session app, initialize full screen mode, launch the second session app opening to the order history, and then invoke the returns smart service to open the return approval view with the reconciled refund summary for the seller to enter the approval ID, drop-off address, and return instructions in memory in operation 842; (d) in response to the seller tapping the notify button in the return-approval view, the second session app requests the core to perform a tap-to-message process to create the branded return-approved message with a URL encoded with the temporary table and posted to a message bar through an IPC also in operation 842; and (e) in response to the seller tapping the send button, the messaging host transmits the branded return-approved message to both devices with callbacks, and the core on the sending device updates data in memory and timestamped return-approved step in the temporary table, and then saves the table back to the assigned cache in the second session app in operation 844.

In preparation to return the ordered items for a refund, a customer needs to get the tracking number and estimated time of arrival for delivery through a carrier or curbside drop-off. Then, the customer taps the received return-approved message for a specific order in the transcript to locate the order number in the order history, and then tap the shipped button to pop up a return-shipment view for adding delivery details and replying to the seller with a branded return-shipped message. In one embodiment, a method for a customer to update a received branded return-approved message and reply with a branded return-shipped message to the respective seller, while the approved step is progressed to the shipped step via a tap-to-update and then a tap-to-message processes, is explained by operations 846 and 848: (a) in response to the customer tapping the received return-approved message in the transcript on the first device, the active core receives a callback and performs a tap-to-update process to decode data from a URL into memory, invoke the evaluation process, call a specific action-key-based smart service API to check data integrity and privacy and finish processing the data in the URL, then the core resumes to save the table back to the assigned cache, initialize full screen mode, launch the first session app opening to the order history, and invoke the returns smart service to open a return-shipment view for the customer to specify a delivery method, a tracking number and an estimated time of arrival in memory in operation 846; (b) in response to the customer tapping the notify button in the return-shipment view, the first session app requests the core to perform a tap-to-message process to create the branded return-shipped message encoded with the temporary table and posted through an IPC to a message bar also in operation 846; and (c) in response to the customer tapping the send button, the messaging host transmits the branded return-shipped message to both devices with callbacks, and the core on the sending device updates data in memory and timestamped return-shipped step into the temporary table, and then saves the table back to the assigned cache in the first session app in operation 848.

To get ready for transferring a refund for a returned package, a seller needs to verify if the returned items arrived as promised and in acceptable conditions as described in the returns policy. If they are, the seller transfers money in the amount computed in the reconciled refund summary, and informs a respective customer that refund is on the way by tapping the respective received return-shipped message in the transcript to open the order history to tap the paid button. When the refund payment view opens, the seller verifies the refund transfer summary and taps the notify button to reply to the customer with a branded return-refunded message. In one embodiment, a method for a seller to update a received branded return-shipped message and then reply with a branded return-refunded message to a respective customer, while the shipped step is progressed to refunded step via a tap-to-update process, is explained by operations 850 and 852: (a) in response to the seller tapping the received return-shipped message in the transcript on the second device, the active core receives a callback and performs a tap-to-update process to decode data from a URL to the temporary table, invoke the evaluation process, call a specific action-key-based smart service API to check data integrity and privacy and finish processing the data in the URL, then the core resumes to save the table back to the assigned cache in the second session app, initialize full screen mode, launch the second session app opening to the order history, and then invoke the returns smart service to open the return-refunded view for the seller to verify refund-payment summary in operation 850; (b) in response to the seller tapping the notify button, the core performs a tap-to-message process to generate a branded return-refunded message with a URL encoded with the temporary table and posted to a message bar through an IPC also in operation 850; and (c) in response to the seller tapping the send button, the messaging host transmits the branded return-refunded message to both devices with callbacks, and then the core on the sending device updates the timestamped return-refunded step in the temporary table, and then saves the table back to the assigned cache in the second session app in operation 852.

When a customer is notified by a specific payment service about a refund payment made by a specific seller, it is necessary for the customer to tap the respective received return-refunded message in the transcript for the active core to perform a tap-to-update process to have the return-refund data updated in the temporary table and the first session data model cache in order to close the return-refund request. In one embodiment, a method for a customer to update a received branded return-refunded message and send a branded refund-confirmed message to the respective seller, while a one-time update is performed by the core on the sending device and then by the core on the receiving device for synchronizing reconciled return-refund data when the workflow is complete is explained by operations 854, 856 and 858: (a) in response to the customer tapping the received branded return-refunded message in the transcript on the first device, the active core receives a callback and performs a tap-to-update process to decode data from a URL into memory, invoke the evaluation process, call a specific action-key-based smart service API to check data integrity and privacy and finish processing the data in the URL, then the core resumes to save the table back to the assigned cache, initialize full screen mode, launch the first session app opening to the order history, and invoke the returns smart service to open the refund confirmation view for review; in response to the customer tapping the notify button, the core performs a tap-to-message process to create and send the branded refund-confirmed message encoded with the temporary table in operation 854; (b) in response to the customer tapping the send button, the messaging host transmits the branded return-refunded message to transcripts on both devices, and the core on the sending device updates the order history, return-refund data, return-shipment table, and SKU table in the first session data model cache, opens the first session app to the order history UI to display the return shipment and return-refund summary, and then deletes the assigned cache to free up device storage space in operation 856; and (c) in response to the seller tapping the received branded refund-confirmed message in the message transcript on the second device, the active core receives a callback confirmation, decodes the temporary table and metadata in the URL, calls a respective action-key-based smart service API to update the order history, return-refund data, return-shipment table, and SKU table in the second session data model cache, opens the second session app to the order history UI to display the return shipment and return-refund summary, and saves the temporary table as a journal entry for the audit trail, and then deletes the assigned cache to free up device storage space in operation 858. Therefore, when an order-return-refund workflow progresses to a refund-confirmed step for a specific order, the data model caches of both session apps are consistently updated for reconciled return-refund data, and the assigned caches are deleted to free up device storage space. Further, the method using a single temporary table to manage return-refund data enables the data model caches of both session apps to remain the unchanged even if either the customer or the seller exits the workflow before a refund is issued. This approach eliminates the need for rollbacks to previous versions, as would be required in a client-server system, when return requests are canceled or dropped.

According to one aspect of the embodiments described herein relates to a multi-store shopping system configured on a seller's multiple devices to facilitate customers to shop across stores. By using unique PINs to differentiate the first-registered and storefront devices signed in with the same email address, the second session app appoints the seller using the first-registered device to act as the distributor and the ones using storefront devices to act as publishers. Subsequently, the system utilizes a store-as-a-service model to enable the distributor to create working copies and distribute production copies of assigned stores to registered storefront devices for authorized publishers to customize promotions by user groups and publish with respective production copies on the storefront devices to subscribed user groups, enabling multi-store shopping by subscribers who belong to multiple groups. Additionally, the app presents role-based UIs for the distributor on the first-registered device to access the store manager UI to create and share the store assignment list with publishers to be used for planning, and each publisher on a respective storefront device can access the group manager UI to create user groups to subscribed to stores on the subscription list, which can be shared with the distributor for getting privileges to customize promotions in the read-only production copy of stores, which will be published to subscribed user groups to facilitate multi-store shopping. This approach safeguards data integrity by storing working and production copies of stores on the assignment list in separate caches on the first-registered device, production copies with custom promotions of stores on the subscription list and production copy for subscribed user groups in separate caches on respective publishers' storefront devices, and production copies of subscribed stores on customers' devices. The methods and details are described and explained below with examples.

FIG. 9 is a flow diagram illustrating a method for configuring a multi-store shopping system on a seller's multiple devices through the distributor's assignment list and publishers' subscription lists in accordance with one or more embodiments. In one embodiment, a multi-store shopping system is configured on a seller's multiple devices signed in with the same email address but distinguished by unique PINs. The second session app leverages these PINs to present user-role-based UIs to configure a multi-store shopping system through tap-to-message and tap-to-update processes with a method includes: (a) the distributor and publishers tap an action button to send individual device profiles to the distributor, who replies with the device registry for publishers to update their respective session data model caches with unique device PINs for the second session app to verify the user roles and device PINs to ensure that the distributor is the store content owner with full access to store working copies, and authorized publishers are the store managers with full access to store promotions customized by user groups for stores on their subscription lists; (b) the distributor accesses store manager UI to assign each store to all storefront devices in the registry, and tap the assign button to generate and send the assignment list to publishers, who can then tap the received messages and update the list to their session data model caches to be used for planning; (c) the distributor creates product collections in the editor for each store on the assignment list, and distribute each assigned store with branded store message and serialized attachments via tap-to-message and serialization processes to a group of publishers, who can then tap to update the message to directly access the default store with preset photos and data, copy the attachment files to be deserialized in the container app, updated in the second session data model cache, and moved to the application sandbox on a respective storefront device, and then tap the message again for the core to launch the second session app to open to the production copy of the specific store for read-only review and subsequent pairing with user groups to make a subscription list; (d) each publisher accesses the group manager UI to create user groups with unique names across storefront devices, subscribe them to reviewed stores in the group manager UI, and tap the subscribe button to generate and send the subscription list to the distributor, who can verify the details and then grant approval to publishers with privileges to add custom promotions to production copies of stores on the subscription list; (e) each publisher can tap the received branded approved message for the second session app to activate the promotion manager, publish button, order history, and sales analytics UIs; (f) each publisher creates promotion methods and schedules tailored by subscribed user groups, which are included in the respective production copies and published to the subscribed user groups through tap-to-message process; and (g) group members who opt-in as subscribers can tap each received branded store message to trigger a tap-to-update process to access the default store, copy the attachments to be deserialized in the container app, updated in the second session data model cache, and moved to the application sandbox, and tap the message again in respective transcripts for the core to launch the first session app that opens the store homepage on each subscriber device for in-app shopping with photos, metadata, promotions, business policies, store collections, and data model cache streams retrieved and populated in store UIs, and subscribers belonging to multiple user groups can repeat the process to subscribe to more stores to make purchases and track orders through respective publishers seamlessly.

Referring to FIG. 9, the example demonstrates a configuration of multi-store shopping system 900 with a seller 221 participating with three devices 220, 260 and 280, and a subscriber 201 belongs to user groups 2 and 3 and shops in stores 2 and 3. All devices are signed in with the same email address but differentiated with unique PINs in their respective registration profiles. These PINs are referenced by the second session app to present custom UIs based on user roles (distributor or publisher) and device identities (first-registered or storefront device). Furthermore, the example configuration includes: the distributor 221 on the first-registered device 220, one publisher 223 on the storefront device 226, and another publisher 225 on the storefront device 228 are running the second session app 222b, and a subscriber 201 on a client device 200 is running the first session app 202a. This multi-store shopping system is configured with a method comprising: (a) in response to the distributor 221 tapping the assign button in the store manager UI 920, the second session app 222b updates the assignment list in the session data model cache on the first-registered device 220, requests the core to perform a tap-to-message process to share the list with publishers 223 and 225, who can then update the list in their respective session data model caches via a tap-to-update process for planning purposes; (b) in response to the distributor 221 tapping the distribute button in the editor UI for the store 1 created and assigned by the distributor, the second session app invokes the process to serialize oversized multimedia store files into attachments, and requests the core to generate and send a branded store message with attachments to message transcripts on devices 220 and 226; repeat the step to distribute the respective branded store message for store 2 to transcripts on devices 220 and 226, and for store 3 to transcripts on devices 220 and 228; (c) in response to each publisher tapping each received branded store message in the transcript, the core receives a callback and performs a tap-to-update process to directly access the default store view with preset photos and data; and in response to copying the attachment files by the publisher, the container app's smart service API deserializes these files that can be updated in the second session data model cache and moved to the application sandbox; in response to the publisher tapping the message again, the core performs a tap-to-update process to launch the second session app to open to the production copy of the specific store for read-only review and subsequent pairing with user groups on the respective storefront device; (d) in response to the publisher 223 tapping the subscribe button in the group manager UI 940, after having created user group-1 and group-2 and subscribed them to stores 1 and 2 on storefront device 226, the core performs a tap-to-message process to generate a branded subscription-list message to be transmitted to message transcripts for updating the subscription list into both session data model caches on the first registered device 220 and the storefront device 226; repeat the step to tap the subscribe button in the group manager UI 942 for updating the subscription list into both session data model caches on the first registered device 220 and the storefront device 228; (e) in response to the distributor 221 tapping the received branded subscription-list message in the transcript, the core receives a callback and performs a tap-to-update process to update the subscription list in the second session data model cache and launch the second session app to open the approval UI for the distributor to verify the subscription list with store review statuses, and then tap the notify button to reply to the publisher 223 with a branded approval message via a tap-to-message process; and repeat this operation to generate and send the approval message to the publisher 225; (f) in response to each publisher tapping respective received approval messages, the second session app activates the promotion manager, publish button, order history, and sales analytics UIs on storefront devices 226 and 228; (g) in response to tapping the promotion-manager button in the editor UI, each publisher can customize promotion methods and schedules by user groups and test results through the pricing model without repeating computations for the same order to quickly finalize the custom promotions, and then tap the publish button for the core to generate and send a branded store message and serialized attachments to message transcripts on devices used by the same user group, such as device 226 used by publisher 223 and device 200 used by customer 201 in one user group, and then device 228 used by publisher 225 and device 200 used by customer 201 in another user group; and (h) in response to the customer 201 tapping the received branded store message sent by a publisher 226 and then a publisher 228 to the transcript, the core performs a tap-to-update process to directly access the default store view with preset photos and data; and in response to copying the attachment files to the container app to be deserialized and then updated in the first session data model cache, the customer 201 taps the message again to launch the first session app to open to the production copies of stores 2 and 3 with multimedia data for shopping and tracking. Therefore, belonging to user group-2 and group-3, Jane, the subscriber and customer 201, can shop and place orders with stores 2 and 3 within the first session app 202a and get receipts 960 and 962 from respective publishers 223 and 225.

In one embodiment related to comprehensive sales analytics, each publisher can tap the analytics button in a second session app on their respective storefront devices, triggering the core to perform a tap-to-message process to generate a branded analytics message and a serialized attachment document containing time series data and hash tables, and notify the messaging host to transmit the message and transfer the attachment to message transcripts on the first-registered and current storefront device. When the distributor tapping the received message, the core performs a tap-to-update process to open to a default view. When the attachment is copied to the container app in the operating system and deserialized by a specific smart service API, the distributor is returned to the messaging app to tap the same branded message again to refresh the comprehensive sales analytics on the first-registered device for evaluating product collections across all stores to improve respective offerings. Additionally, publishers receive updated sales analytics automatically when outstanding orders are updated to the payment-received status for stores on their own storefront devices for evaluating promotion methods and performances.

The ecommerce messaging system of the disclosure comprises one or more ecommerce extension apps working in conjunction with the native messaging app to implement in-app stores and order workflows. Specifically, the system streamlines data exchange between customer and seller session apps built on distinct entity data models by generating and updating branded messages through robust tap-to-message and tap-to-update processes standardized by a hybrid of action-key-based smart service APIs, and leverages the messaging app to send and receive branded messages and store attachments within the same transcripts on participating smartphones and tablets. This is achieved by running session apps one at a time on sending or receiving devices. When the messaging host detecting the same app key, branded messages about a specific order and in-app store appear in the same message transcripts on devices used by the same user group. The system is a viable alternative to conventional client-server systems used by online ecommerce websites.

According to one aspect of the embodiments described herein relates to the ecommerce messaging system (the system) 1000 comprising two or more ecommerce extension apps 1010 working within a messaging app 1008. Specifically, an ecommerce extension app of the disclosure comprises two session apps 202a and 222b that offers distinct entity data models 1028 and 1048 to serve customers and sellers on devices 200 and 220 respectively with efficient data processing by sharing the same set of frontend- and backend-driven smart services 1060, enabling the extension core 1020 (the core) to update data between session apps 202a and 222b by performing tap-to-message processes on the sending devices to generate branded messages encoded with URLs, and tap-to-update processes on the receiving devices to decode URLs, update session data model caches, and access deep link views for further action, while a messaging host 1006 sends and receives branded messages in message transcripts, 204a and 224b, on devices 200 and 220 within the same user/message group. Additionally, the system facilitates processing order workflows with one-on-one communication between a customer 201 and a seller 221, publishing and subscribing to in-app stores with one-to-many communication between a seller and a subscribed user group, and configuring a multi-store shopping system with role-based communication between the distributor on the first-registered device and publishers on storefront devices. The specifications of two session apps, smart services and the core of the ecommerce extension app are explained below, followed with implementation examples illustrated in FIG. 10A and FIG. 10B.

In one embodiment on entity-data-model-based session apps, the system provides two session apps 202a and 222b, each with a distinct entity data model structured around a central core in three layers. The action layer, located in the outermost rectangle and represented by 1022 for the first session app 202a and 1042 for the second session app 222b, includes the action key assigned by a session app for identifying the class of communication in response to a user tapping an action button, such as a place-order button in a checkout UI and the publish button in an editor UI. To facilitate processing order workflows, an action key is first encoded in a tap-to-message process, and then decoded and identified by the evaluation process in all subsequent tap-to-update processes in the workflow, enabling the core to call the corresponding smart service API to ensure consistent and error-free processing of status updates. Next to the outermost layer, the user interface layer, represented by 1024 for the first session app and 1044 for the second session app, interacts with the respective business logic layers, 1026 and 1046. These business layers, in turn, communicate with the respective entity data models 1028 and 1048, located at the center, and with both user interface layers, 1024 and 1044, enabling customers to seamlessly navigate between inter-connected UIs to work with live data computed by pricing business rules through propagation of updates by the first session app, and sellers to have order-payment and return-refund data reconciled by business rules, updated in second session data model caches, and presented in deep link views for further review, action, and data synchronization between session data model caches. Moreover, the onion-like architecture of session apps is suitable for complex business systems, enabling greater cohesion among component layers with fewer dependencies. This flexibility empowers the system to adapt to evolving business requirements such as integrating action-key-based computation with tap-to-message and tap-to-update processes at the order level, working in conjunction with serialize-deserialize process at the file level during tap-to-message and tap-to-update processes, leading to simplified UIs and smooth user experience.

In one embodiment on frontend- and backend-driven smart services, smart services 1060 are initialized and activated by the core 1020 to support the business logic layers 1026 and 1046 that are defined by respective entity data models 1028 and 1048 within respective session apps 202a and 222b. To perform a tap-to-message process, the core calls action-key-based smart service APIs 1060 to generate branded messages with URLs containing data specific to a user group and in-app store or order workflow. Through tap-to-update processes, the core calls an action-key-based smart service API 1060 to reconcile prices based on promotions and the pricing model, update changes into session data model caches, and assemble data required for opening deep link views to review and act, while keeping order-payment data between session data model caches synchronized in workflows. Additionally, smart services can be interface-driven. In one or more embodiments, the core 1020 can call an action-key-based smart service API 1060 to present a promotion manager UI 1062 where sellers can select promotion discounts and checkout deals, monitor promotion schedules in a calendar view, and test promotion effects with built-in business logic 1064 through a checkout UI adapted from the first session app. Moreover, smart services can call on each other through the core for efficiency, including a smart service for a calendar planner communicating with a smart service for checkout discounts to compute sale prices during the promotion period. In another embodiment, smart services can compute and present top best sellers by sales for a specific in-app store in a photo gallery, top collections by quarterly sales in charts, and quarterly comparisons of net and gross sales in a tabular report, for instance.

In one embodiment on the extension core 1020 manages session apps 202a and 222b and smart services 1060 for generating and updating order workflows and in-app stores through branded messages with URLs, and communicate with the native messaging host via an IPC framework to send and receive branded messages in message transcripts on devices used by customers and sellers in the same user groups. In one embodiment, the core 1020 of an ecommerce extension app 1010 is configured to optimize the user interfaces 1024 and 1044 with precise distribution of user gestures captured by the operating system to the currently active session app or smart service, as well as identify the action key for efficiently calling the correct smart service APIs to construct the branding images and URLs in tap-to-message processes, as well as verify data integrity and privacy to finish processing data in URLs, reconcile order-payment data that can be merged into order histories and updated in session model caches, and assemble computed data for subsequent deep link view for further action in tap-to-update processes. In another embodiment, the core 1020 works exclusively with the messaging host 1006 by sending an API command to the messaging host to post the current branded message to the message bar via IPC 206 within a tap-to-message process, and responding to callbacks issued by the messaging host confirming a user tapping a send button in a message bar to transmit a branded message or transfer a store attachment, or tapping a received branded messages in a message transcript to trigger a tap-to-update process. Consequently, the core supports various communication models to process order workflows between a customer and a seller, publish in-app stores between a seller and a group of customers, and configure a multi-store shopping system between a distributor and a group of publishers. Additionally, the core activates the first session app to propagate dynamic updates to related memory objects to refresh their interconnected shopping UIs automatically for customers to work with consistent data, the second session app to scale a small-format store on one seller device to multi-store shopping systems by adding more seller storefront devices, and the resource-saving approach to manage return-refund workflows with temporary tables before one-time updates on each participating session app upon completion of workflows.

FIG. 10A illustrates two ecommerce extension apps in the ecommerce messaging system with a customer 201 using a first session app 202a on the first device 200 and a seller 221 using a second session app 222b on the second device 220, who can communicate with branded messages displayed in message transcripts, 204a and 224b, through messaging host 1006. Furthermore, each extension app comprises the extension core 1020, two alternating session apps, 202a and 222b, and smart services 1060. These two extension apps on respective sending and receiving devices can work with the messaging host 1006 alternately, enabling a messaging host to identify both session apps with the same app key for sharing the same set of branded messages in message transcripts 204a and 224b on both devices 200 and 220 used by the same user group through status updates at the ordered, invoiced, paid, shipped, and delivered stages within order workflows. An order workflow example illustrates how the system works. This workflow leverages action-key-based computation to prepare data for various ecommerce functions. Starting with a customer placing an order, the first session app, which manages order histories, efficiently clusters the order request into shipments based on the fulfillment channel. This method pre-loads data into separate data model caches at the beginning. This eliminates the need for expensive data processing between databases later, as is common in client-server systems. As the order progresses from being placed at the ordered stage to being billed at the invoiced stage, an action-key-based smart service can automatically compute up-to-date order-payment summaries. These summaries leverage the accurate data stored in the second session data model cache. The system then replaces the possibly outdated summary on the customer's device through a tap-to-update process. This proactive approach ensures customers have the latest information for payment, even if they miss store update messages accidentally. Furthermore, sellers need to evaluate sales analytics to update promotion methods and timing. Upon reaching the paid stage, the core automatically converts order transaction data into time-series components categorized by specific time periods. This data is then incrementally updated, ensuring sellers' devices always have the latest sales analytics. These efficient, action-key-based calculations are performed at the record level, further safeguarding data integrity. Additionally, they are conveniently coordinated with ongoing tap-to-message and tap-to-update processes.

The following methods outline how the ecommerce messaging system processes an order workflow, from the ordered stage to the invoiced stage as shown in FIG. 10A, through the core managing session apps and smart services to perform tap-to-message and tap-to-update processes and action-key-based computation: (a) in response to a customer tapping the place-order button in the checkout view on the first device, the core performs a tap-to-message process to generate and send a branded order-requested message; in response to the callback confirming the transmission to message transcripts, the core updates the timestamped order-requested status in the first session data model cache; (b) in response to a respective seller tapping the received message triggering callbacks, the core performs a tap-to-update process to decode the URL, call an action-key-based smart service API to reconcile prices and compute a new order-payment summary that is merged with the timestamped order-requested status into the order history, and updated in the second session data model cache, then the core launches the second session app opening to a deep link view with reconciled order-payment summary and explanations of differences, allowing the seller to review and tap the notify button to reply to the customer with a branded payment-requested message; in response to the callback, the core updates the timestamped payment-requested status in the second session data model cache; and (c) in response to the customer tapping the received message in the transcript, the core receives a callback and performs a tap-to-update process to call a smart service API to replace the existing order-payment data with the one decoded from the URL, so that the reconciled order-payment data is synchronized between session data model caches, then the core launches the first session app opening to a deep link view with the reconciled order-payment summary and explanations of price differences, allowing the customer to review, pop up the payment services view, and tap the pay button to make payment through a native payment service or third party website; in response to the callback, the core on the sending device calls the first session app to update the timestamped payment-requested status in the entity data model cache. This interaction cycle between a customer and a seller to execute a tap-to-message process on the sending device, send and receive branded messages in transcripts via a messaging host, and then execute a tap-to-update process on a receiving device continues until the order workflow is completed. The details are described and explained below.

FIG. 10A is a schematic diagram illustrating an ecommerce messaging system explained through an order workflow for status updates at the ordered and invoiced stages in accordance with one or more embodiments. To demonstrate how the core manages session apps and smart services and communicates with a messaging host, the system implements an order workflow example starting with a customer sending a branded order-requested message for the seller to update reconciled order-payment data at the ordered stage and reply with a branded payment-request message, and then progressing to the invoiced stage to replace existing data with reconciled order-payment data on the customer device and synchronize order-payment data between session apps. An order workflow example for explaining the system's functionality, as illustrated across FIG. 10A, involving a method comprising: (a) in response to the customer 201 tap on the place-order button in the checkout view displaying an order summary, a first session app 202a invokes a cluster process to compute split-shipment data that is then merged with specific order data in preparation for a unified order history, assigns an action key to identify the class of communication, and requests the core 1020 to perform a tap-to-message process to call action-key-based smart service APIs to generate a branded order-requested message with a branding image and a URL encoded with shopping cart data, timestamped order-requested status, action key, and split-shipment data; in response to the customer tapping the send button, the core sends an API command for the messaging host 1006 to transmit both message transcripts, 204a and 224b, with callbacks 206 for the core on the sending device 200 to call the first session app to update the timestamped order-requested status in the entity data model cache 1028; (b) in response to the seller 221 tapping the received branded order-requested message in a message transcript 224b, the active core receives a callback 208 and performs a tap-to-update process, decoding data in the URL, invoking the evaluation process for second session app launch preparations, calling a respective action-key-based smart service API 1060 to extract prices and deals from the second session data model cache to compute a new order-payment summary, merge the reconciled order-payment data, timestamped order-requested status, and split-shipment data into the order history, update the summary, status, and data in the second session data model cache, and assemble the required data for a subsequent the deep link view, then the core initializes full-screen mode, and launches a second session app 222b to open the payment-request view with the reconciled order-payment summary and explanations of price differences for action; (c) in response to the seller 221 tapping the notify button in the view, the core 1020 performs a tap-to-message process to generate and reply to the customer 201 with the branded payment-requested message including a branding image and a URL encoded with reconciled order-payment data and timestamped payment-requested status via a tap-to-message process with callbacks for the core on the sending device to call the second session app to update the timestamped payment-requested status in the entity data model cache 1048; and (d) in response to the customer tapping the received branded payment-request message, the messaging host 1006 issues callbacks, and the core on the receiving device 220 performs a tap-to-update process to call the smart service API 1060 to replace the matching order-payment data in the order history and first session data model cache with the one decoded from the URL including the timestamped order-requested status, ensuring both session data model caches are synchronized with the latest order-payment information for the specific order to maintain data integrity. Consequently, the system leverages the same smart service API to update a set of order statuses through tap-to-update processes, each followed by a tap-to-message process to reply to the sender with the next status update if the notify button is available, which can be repeated until all packages in the same order for a specific store are delivered upon completion of the workflow.

FIG. 10B illustrates two ecommerce extension apps with a seller 221 using a second session app 222b on the second device 220, and a customer 201 using a first session app 202a on the first device 200, who can communicate with branded messages displayed in message transcripts, 224b and 204a, through messaging host 1006. In one embodiment to use a temporary table to store return-refund data within an order-return-refund workflow, both first and second session data model caches for a respective order can remain unchanged until the workflow is completed and one-time updates in both data model caches can be executed. To process a return-refund workflow for a specific order, a customer taps the returns button for a delivered package containing the items to be returned in the order history to select the items and reasons for the return, and then tap the notify button for the first session app to request the core to perform a tap-to-message process at the return-requested step. To continue to return-approved, return-shipped, return-refunded, and refund-confirmed steps on the sending and receiving devices in the workflow, the system leverages the same smart service API to update these steps through tap-to-update processes, each followed by a tap-to-message process to reply to the sender with the next transaction update. When the workflow is completed at the refund-confirmed step, the system executes a one-time update on the sending and receiving devices to synchronize reconciled return-refund data for a specific order within the same in-app store.

Processing a return-refund workflow from the return-approved step to the return-shipped step in ecommerce messaging system as illustrated in FIG. 10B is outlined as follows: (a) in response to the seller 221 tapping the received branded return-requested message in the transcript, the active core 1020 receives a callback and performs a tap-to-update process to decode data from a URL in the temporary table, call a specific smart service API 1060 to finish processing the data in the URL, save the table back to the assigned cache in the second session app 222b, and invoke the returns smart service to open the return approval view with the reconciled refund summary for the seller to enter the approval ID and instructions in memory; in response to the seller tapping the notify button, the core generate and send a branded return-approved message via a tap-to-message process with callbacks, then the core on the sending device 220 updates data in memory and timestamped approved step in the temporary table, and then saves the table back to the assigned cache in the second session app; and (b) in response to the customer tapping the received return-approved message when the shipping details on the items to be returned are available, the active core 1020 receives a callback and performs a tap-to-update process to decode data from a URL in the temporary table, call a specific smart service API 1060 to finish processing the data in the URL, save the table back to the assigned cache in the first session app 202a, and invoke the returns smart service to open the return shipment view with the reconciled refund summary for the customer to specify a delivery method, a tracking number and an estimated time of arrival in memory; in response to the customer tapping the notify button, the core generate and send a branded return-shipped message via a tap-to-message process with callbacks, then the core on the sending device 200 updates data in memory and timestamped shipped step in the temporary table, and then saves the table back to the assigned cache in the first session app.

FIG. 10B is a schematic diagram illustrating an ecommerce messaging system explained through a return-refund workflow at specific steps in accordance with one or more embodiments. To demonstrate how the core manages session apps and smart services, and communicates with a messaging host for processing a return-refund workflow in the system, an implementation where a seller 221 on the second device 220 taps a received branded return-requested message in a transcript to trigger a tap-to-update process and reply with a return-approved message with approval ID and instructions, and then a respective customer 201 on the first device 200 taps the received message in the shared transcript to also trigger a tap-to-update process and reply with a return-shipped message using a method to update transaction steps through a temporary table and assigned caches comprising: (a) in response to the seller 221 tapping the received branded return-requested message in the transcript 224b on the second device 220, the active core 1020 receives a callback and performs a tap-to-update process to decode data from a URL to the temporary table, invoke the evaluation process, call a specific action-key-based smart service API 1060 to check data integrity and privacy and finish processing the data in the URL, then the core resumes to save the table back to the assigned cache in the second session app, initialize full screen mode, launch the second session app 222b opening to the order history, and then invoke the returns smart service to open the return approval view with the reconciled refund summary for the seller to enter the approval ID, drop-off address, and return instructions in memory; (b) in response to the seller 221 tapping the notify button in the view, the second session app 222b requests the core to perform a tap-to-message process to create the branded return-approved message with a URL encoded with the temporary table and posted to a message bar through IPC 206; (c) in response to the seller 221 tapping the send button, the core 1020 notifies the messaging host 1006 to transmit the branded return-approved message to message transcripts, 224b and 204a, on both devices, 200 and 220; upon receiving the callback 208, the core on the sending device updates the data in memory and timestamped approved step into the temporary table, and then saves the table back to the assigned cache in the second session app; (d) in response to a customer 201 tapping the received return-approved message in the transcript 204a on the first device 200, the active core receives a callback and performs a tap-to-update process to decode data from a URL into memory, invoke the evaluation process, call a specific action-key-based smart service API 1060 to check data integrity and privacy and finish processing the data in the URL, then the core resumes to save the table back to the assigned cache, initialize full screen mode, launch the first session app 202a opening to the order history, and invoke the returns smart service to open a return-shipment view for the customer to specify a delivery method, a tracking number and an estimated time of arrival in memory; (e) in response to the customer 201 tapping the notify button in the return-shipment view, the first session app 202a requests the core to perform a tap-to-message process to create the branded return-shipped message encoded with the temporary table and posted to a message bar through IPC; and (f) in response to the customer 201 tapping the send button, the core 1020 notifies the messaging host 1006 to transmit the branded return-shipped message to message transcripts, 204a and 224b, on both devices, 200 and 220; upon receiving the callback, the core on the sending device updates the data in memory and timestamped shipped step in the temporary table, and then saves the table back to the assigned cache in the first session app. If customers decide to skip shipping back the items to be returned, there is no need to undo any transaction updates since the respective data model caches of both session apps remain unchanged, which is not the case in conventional client-server systems.

Reference to an “embodiment” in this document does not limit the described elements to a single embodiment; all described elements may be combined in any embodiment in any number of ways. Furthermore, for the purposes of interpreting this specification, the use of “or” herein means “and/or” unless stated otherwise. The use of “a” or “an” herein means “one or more” unless stated otherwise. The use of “comprise,” “comprises,” “comprising,” “include,” “includes,” and “including” are interchangeable and not intended to be limiting. Also, unless otherwise stated, the use of the terms such as “first,” “second,” “third,” “outer,” “inner,” and the like do not denote any spatial, sequential, or hierarchical order or importance, but are used to distinguish one element from another.

These various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of embodiments as defined in the claims that follow.

What is claimed is:

1. A method for one or more ecommerce extension apps on their respective client devices, working in conjunction with a messaging app, the method comprising:
in response to a user tapping an action button within a session app, an ecommerce extension core performing a tap-to-message process, wherein the process includes staging order or store data, a timestamped status, and an action key that identifies the communication class to set up data for a URL, calling smart service APIs (application programming interfaces) to encode the staged data into the URL and overlay a dynamically computed branding image to generate a branded message to be posted to a message bar via an IPC (interprocess communication), allowing the user to tap the send button to have the message transmitted to message transcripts on devices used by the user group via a messaging host with callbacks to trigger the core on the sending device to call the session app to update the timestamped data in the entity data model cache;
in response to a callback confirming a recipient tapping a received branded message in a message transcript, the active core performing a tap-to-update process, wherein the process includes decoding data and the action key in a URL, invoking the evaluation process for session app launch preparations, and calling an action-key-based smart service API to finish processing the data in the URL, update entity data and action-key-based computation in the receiving session data model cache, and assemble data required for opening a subsequent deep link view, then the core initializes full-screen mode, and launches the session app that opens the view for further action; if present, an action button enables a tap-to-message reply to the sender for the next status update in the workflow;
performing, through one or more memory objects, dynamic updates by a first session app and smart services using APIs to create and update memory objects, apply business rules to the items merged in search results and shopping carts, and store results in memory objects to compute prices that are updated in the first session data model cache on the first device and displayed in the current UI (user interface), and then the first session app propagates these changes to memory objects associated with the shopping list, order list, checkout, and dynamic checkout widget UIs in the active store, refreshing these interconnected UIs automatically;
processing, within an order-return workflow, return-refund data by order number in a temporary table that is also stored in assigned caches to keep the first and second session data model caches unchanged until the workflow is complete for the core to perform a one-time update in the sending and receiving session apps with data in the temporary table, wherein the core on the sending device receives a callback confirming a first user (customer) tapping the send button to transmit a branded refund-confirmed message with a URL to message transcripts via a messaging host, extracts from the temporary table and updates the order history, return-refund data, return-shipment table, and SKU table in the first session data model cache, and wherein the core on the receiving device receives a callback confirming a second user (seller) tapping the received refund-confirmed message in the transcript, performs a tap-to-update process to decode the temporary table in the URL, and calls an action-key-based smart service API to update the order history, return-refund data, return-shipment table, and SKU table in the second session data model cache; and
configuring, with second session apps, a multi-store shopping system utilizing a store-as-a-service model and facilitates role-based communication between the distributor and one or more publishers for first users to subscribe to multiple stores created by the distributor and managed by respective publishers; wherein the second session app identifies a second user's multiple devices by unique PINs to appoint the second user on the first-registered device to act as the distributor and the ones on storefront devices to act as publishers, and customizes the UIs for the distributor to create store assignment list and distribute store production copies to publishers, and for publishers to create user groups on their storefront devices to generate and share individual subscription lists with the distributor to get approval to add custom promotions to their production copies and publish them to subscribed user groups, allowing first users to conveniently shop across multiple stores.

2. The method as in claim 1, wherein branded messages are categorized by action keys for the extension core to identify action-key-based smart service APIs to perform various functions, including to construct URLs, send order requests, publish stores, and compute time-series data in tap-to-message processes, as well as verify decoded URL data for data privacy and integrity, reconcile prices, update order statuses, and merge data into order histories in tap-to-update processes, and wherein branded messages consist of branded images and URLs encoded with data and metadata, which can include timestamped order statuses from order workflows, return-refund data extracted from temporary tables, placeholder parameters for collections within in-app stores, assignment and subscription lists used for configuring multi-store systems, and additional metadata such as group IDs, store IDs, sender IDs, recipient IDs, branded message IDs, and action keys assigned by session apps.

3. The method as in claim 1, wherein a first session app merges product data, including SKU-identified item prices, quantities, styles, and promotions for items selected from search results and shopping carts, sorts the merged items based on selected filters, recomputes deal prices and checkout savings based on promotion business rules only if product attributes and quantities of a selected category item have changed, saves these changes in the first session data model cache, updates memory objects and refreshes the current UI, and propagates dynamic updates to interconnected shopping UIs by leveraging existing shopping, search, and photo data already stored in memory objects within the active store on the device, ensuring data consistency and seamless navigation.

4. The method as in claim 1, wherein the core coordinates tap-to-message, tap-to-update, and serialize-deserialize processes, enabling a second user to publish an in-app store to a group of first users for in-app shopping with a method comprising: (a) in response to a second user tapping the publish button in an editor for the active store, a second session app invokes the process to partition and serialize the store entity data into one or more multimedia attachment files, and requests the core to perform a tap-to-message process to generate a branded store message, notify the messaging host to transmit the message and push the attachments with sequential IDs to transcripts on devices used by the current group with callbacks, and then the core on the sending device saves the timestamped attachment files and group ID in second session data model cache; (b) in response to a first user tapping the received message in the transcript with callbacks, the core performs a tap-to-update process to open to a default store with preset data; (c) in response to the attachments copied over by the first user from the messaging app to the container app, a specific smart service API deserializes the attachments, updates the store entity data streams in the first session data model cache, and moves product photos into the application sandbox; and (d) in response to the user tapping the message in the transcript again, the core launches the first session app to present the store UIs with photos, metadata, promotions, business policies, store collections, and data model cache streams for in-app shopping and order tracking.

5. The method as in claim 1, wherein the core calls an action-key-based smart service API to compute order-payment summaries with the data stored in the second session data model cache to ensure first users to have the accurate payment information when order workflows progress from being requested at the ordered stage to being billed at the invoiced stage with a method comprising: (a) in response to a second user tapping a received order-requested message in a message transcript, the active core receives a callback and performs a tap-to-update process to call the action-key-based smart service API to extract prices and deals from the second session data model cache to compute a new order-payment summary, merge the reconciled order-payment data and timestamped order-requested status into the order history, update the data and status in the second session data model cache, and assemble data required for opening a deep link view, then the core initializes full-screen mode and launches a second session app that opens the payment-request view with the reconciled summary and explanations of price differences; (b) in response to the second user tapping the notify button in the view to reply to the first user, the core generates and sends a branded payment-requested message including a branded image and a URL encoded with the reconciled order-payment data and timestamped payment-requested status via a tap-to-message process with callbacks for the core to call the second session app to update the payment-requested status in the second session data model cache; and (c) in response to the first user tapping the received payment-requested message in the transcript, the active core performs a tap-to-update process to call the smart service API to replace the matching order-payment data in the order history and first session data model cache with the one decoded from the URL. This proactive approach for synchronizing price reconciliation between session apps ensures first users have the latest information for payment, even if they miss tapping store update messages accidentally. For multi-device first users, tapping the received payment-request message on all receiving devices is required to proceed to the next status update in the same order workflow to maintain data integrity; therefore, to view the latest update afterward, they only need to tap on the same branded message on any of their registered devices.

6. The method as in claim 1, wherein processing a return-refund workflow from a requested, approved, shipped, to refunded steps includes extracting return-refund data from a temporary table into memory, verifying data integrity and privacy, and saving the verified data back to the respective assigned cache in the session app, so that the respective order data in the first and second session data model caches remain unchanged without having to rollback transactions to previous versions if a return request is canceled or disqualified, and wherein upon receiving a callback confirmation for a branded refund-confirmed message on the sending and receiving devices, a one-time update for each session app is processed, synchronizing return-refund data between session apps when a return-refund workflow is complete at the refund-confirmed step with a method comprising: (a) in response to a first user tapping the send button for the messaging host to transmit the branded refund-confirmed message with a URL encoded with the temporary table data, the active core receives a callback confirmation, updates the order history, return-refund data, return-shipment table, and SKU table in the first session data model cache, deletes the temporary table and assigned cache to save device space, and then opens the first session app to the order history UI to display the return shipment and return-refund summary; and (b) in response to a callback triggered by a second user tapping the received branded refund-confirmed message on the second device, the active core performs a tap-to-update process, decoding the data in the URL, calling the action-key-based smart service API to update the order history, return-refund data, return-shipment table, and SKU table in the second session data model cache, then the core saves the temporary table as a journal entry for audit trail, and then opens the second session app to the order history to display the return shipment and return-refund summary. This temporary table approach can efficiently handle complex data processing tasks to help client-server systems to offload intensive data processing tasks.

7. The method as in claim 1, wherein a second session app identifies a second user's multiple devices by unique PINs, appoints the second user on the first-registered device to act as the distributor and the ones on storefront devices to act as publishers, and presents role-based UIs for the distributor to create working copies and distribute production copies of assigned stores to a group of publishers for read-only access, and for authorized publishers to customize promotions by user groups created on their storefront stores and publish them with respective production copies to their subscribed user groups for first users belonging to many user groups to shop across stores with a method comprising: (a) in response to the distributor tapping the assign button in the store manager UI, the core generates and sends the branded assignment-list message to a group of publishers via a tap-to-message process; in response to each publisher tapping the received message, the core performs a tap-to-update process to update the store-device assignment list in the second session data model cache on the respective storefront device to be used for planning; (b) in response to each publisher tapping the received branded store message sent by the distributor, having the attachments copied to and deserialized in the container app, and tapping the message again in the transcript, the core performs tap-to-update process to launch the production copy of the store in the second session app for read-only review; (c) in response to each publisher tapping the subscribe button in the group manager UI, the core generates and sends a subscription list of reviewed stores subscribed by user groups created by a respective publisher to the distributor, who verifies the list through a tap-to-update process and replies with a branded approved message via a tap-to-message process to the respective publisher, granting privileges to promote and publish the stores on the subscription list to the subscribed groups; (d) in response to each publisher tapping the received approved message, the second session app activates the promotion manager, publish button, order history, and sales analytics UIs for each publisher to add promotions customized by user groups to a respective production copy, and then publish the store to subscribed user groups; and (e) in response to each subscriber tapping the received branded store message in transcripts sent by a publisher, having the attachments copied to and deserialized in the container app, and tapping the message again in the transcript, the core performs a tap-to-update process to launch the first session app that opens the store homepage with data retrieved and populated across shopping UIs. Moreover, subscribers belonging to multiple groups can repeat the process to access more stores on their own devices for shopping and tracking with respective publishers.

8. A system comprising:
at least one processor; and
at least one non-transitory computer readable storage medium storing executable program instructions that, when executed by the at least one processor, configure the at least one processor to perform operations comprising:
in response to a user tapping an action button within a session app, an ecommerce extension core configured to perform a tap-to-message process, wherein the process includes staging order or store data, a timestamped status, and an action key that identifies the communication class to set up data for a URL, calling smart service APIs to encode the staged data into the URL and overlay a dynamically computed branding image to generate a branded message to be posted to a message bar via an IPC, allowing the user to tap the send button to have the message transmitted to message transcripts on devices used by the user group via a messaging host with callbacks to trigger the core on the sending device to call the session app to update the timestamped data in the entity data model cache;
in response to a callback confirming a recipient tapping a received branded message in a message transcript, the active core configured to perform a tap-to-update process, wherein the process includes decoding data and the action key in a URL, invoking the evaluation process for session app launch preparations, and calling an action-key-based smart service API to finish processing the data in the URL, update entity data and action-key-based computation in the receiving session data model cache, and assemble data required for opening a subsequent deep link view, then the core initializes full-screen mode, and launches the session app that opens the view for further action; if present, an action button enables a tap-to-message reply to the sender for the next status update in the workflow;
performing, through one or more memory objects configured to present and store user inputs, dynamic updates by a first session app and smart services using APIs to create and update memory objects, apply business rules to the items merged in search results and a shopping cart, and store results in memory objects to compute prices that are updated in the first session data model cache on the first device and displayed in the current UI, and then the first session app propagates these changes to memory objects associated with the shopping list, order list, checkout, and dynamic checkout widget UIs in the active store, refreshing these interconnected UIs automatically;
processing, within an order-return workflow, return-refund data by order number configured as a temporary table that is also stored in assigned caches to keep first and second session data model caches unchanged until the workflow is complete for the core to perform a one-time update in the sending and receiving session apps with data in the temporary table, wherein the core on the sending device receives a callback confirming a first user (customer) tapping the send button to transmit a branded refund-confirmed message with a URL to message transcripts via a messaging host, extracts from the temporary table and updates the order history, return-refund data, return-shipment table, and SKU table in the first session data model cache, and wherein the core on the receiving device receives a callback confirming a second user (seller) tapping the received refund-confirmed message in the transcript, performs a tap-to-update process to decode the temporary table in the URL, and calls an action-key-based smart service API to update the order history, return-refund data, return-shipment table, and SKU table in the second session data model cache; and
configuring, with second session apps, a multi-store shopping system utilizing a store-as-a-service model and facilitates role-based communication between the distributor and one or more publishers for first users to subscribe to multiple stores created by the distributor and managed by respective publishers; wherein the second session app identifies a second user's multiple devices by unique PINs to appoint the second user on the first-registered device to act as the distributor and the ones on storefront devices to act as publishers, and customizes the UIs for the distributor to create store assignment list and distribute store production copies to publishers, and for publishers to create user groups on their storefront devices to generate and share individual subscription lists with the distributor to get approval to add custom promotions to their production copies and publish them to subscribed user groups, allowing first users to conveniently shop across multiple stores.

9. The system as in claim 8, wherein an ecommerce extension app enables the core to optimize the user interfaces with precise distribution of user gestures to the currently active session app or smart service, manage a hybrid of APIs with action keys to efficiently retrieve and update order workflow and in-app store data in entity data model caches and memory objects, manage return-refund workflows with temporary tables before the one-time update, scale small-format stores on one device to multi-store shopping by adding more storefront devices, and centralize the communication with the messaging host to transmit branded messages and transfer multimedia attachments and park them in message transcripts ready for tap-to-update processes, and wherein the ecommerce extension core is configured to handle full-screen/compact mode callbacks, support inter-callability between a session app and smart services using common protocol and JSON (JavaScript Object Notation) object interfaces for front-end/back-end processes, and deliver service data to session apps by calling instance APIs.

10. The system as in claim 8, wherein branded messages are categorized by action keys and the extension core is configured to identify action-key-based smart service APIs to perform various functions, including to construct URLs, send order requests, publish stores, and compute time-series data in tap-to-message processes, as well as verify decoded URL data for data privacy and integrity, reconcile prices, update order statuses, and merge data into order histories in tap-to-update processes, and wherein branded messages consist of branded images and URLs encoded with data and metadata, which can include timestamped order statuses from order workflows, return-refund data extracted from temporary tables, placeholder parameters for collections within in-app stores, assignment and subscription lists used for configuring multi-store systems, and additional metadata such as group IDs, store IDs, sender IDs, recipient IDs, branded message IDs, and action keys assigned by session apps.

11. The system as in claim 8, wherein a first session app is configured to merge product data, including SKU-identified item prices, quantities, styles, and promotions for items selected from search results and active shopping cart, sorts the merged items based on selected filters, recomputes deal prices and checkout savings based on promotion business rules only if product attributes and quantities of a selected category item have changed, saves these changes in the first session data model cache, updates memory objects and refreshes the current UI, and propagates dynamic updates to interconnected shopping UIs by leveraging existing shopping, search, and photo data already stored in memory objects within the active store on the device, ensuring data consistency and seamless navigation.

12. The system as in claim 8, wherein the core is configured to coordinate tap-to-message, tap-to-update, and serialize-deserialize processes, enabling a second user to publish an in-app store to a group of first users for in-app shopping with a method comprising: (a) in response to a second user tapping the publish button in an editor for the active store, a second session app invokes the process to partition and serialize the store entity data into one or more multimedia attachment files, and requests the core to perform a tap-to-message process to generate a branded store message, notify the messaging host to transmit the message and push the attachments with sequential IDs to transcripts on devices used by the current group with callbacks, and then the core on the sending device saves the timestamped attachment files and group ID in second session data model cache; (b) in response to a first user tapping the received message in the transcript with callbacks, the core performs a tap-to-update process to open to a default store with preset data; (c) in response to the attachments copied over by the first user from the messaging app to the container app, a specific smart service API deserializes the attachments, updates the store entity data streams in the first session data model cache, and moves product photos into the application sandbox; and (d) in response to the user's tapping the message in the transcript again, the core launches the first session app to present the store UIs with photos, metadata, promotions, business policies, store collections, and data model cache streams for in-app shopping and order tracking.

13. The system as in claim 8, wherein the core is configured to call an action-key-based smart service API to compute order-payment summaries with the data stored in the second session data model cache to ensure first users to have the accurate payment information when order workflows progress from being requested at the ordered stage to being billed at the invoiced stage with a method comprising: (a) in response to a second user tapping a received order-requested message in a message transcript, the active core receives a callback and performs a tap-to-update process to call the action-key-based smart service API to extract prices and deals from the second session data model cache to compute a new order-payment summary, merge the reconciled order-payment data and timestamped order-requested status into the order history, update the data and status in the second session data model cache, and assemble data required for opening a deep link view, then the core initializes full-screen mode and launches a second session app that opens the payment-request view with the reconciled summary and explanations of price differences; (b) in response to the second user tapping the notify button in the view to reply to the first user, the core generates and sends a branded payment-requested message including a branded image and a URL encoded with the reconciled order-payment data and timestamped payment-requested status via a tap-to-message process with callbacks for the core to call the second session app to update the payment-requested status in the entity data model cache; and (c) in response to the first user tapping the received payment-requested message in the transcript, the active core performs a tap-to-update process to call the smart service API to replace the matching order-payment data in the order history and first session data model cache with the one decoded from the URL. This proactive approach for synchronizing price reconciliation between session apps ensures first users have the latest information for payment, even if they miss tapping store update messages accidentally. For multi-device first users, tapping the received payment-request message on all receiving devices is required to proceed to the next status update in the same order workflow to maintain data integrity; therefore, to view the latest update afterward, they only need to tap on the same branded message on any of their registered devices.

14. The system as in claim 8, wherein processing a return-refund workflow from a requested, approved, shipped, to refunded steps is configured to include extracting return-refund data from a temporary table into memory, verifying data integrity and privacy, and saving the verified data back to the respective assigned cache in the session app, so that the respective order data in the first and second session data model caches can remain unchanged without having to rollback transactions to previous versions if a return request is canceled or disqualified, and wherein upon receiving a callback confirmation for a branded refund-confirmed message on the sending and receiving devices, a one-time update for each session app is processed, synchronizing return-refund data between session apps when a return-refund workflow is complete at the confirmed step with a method comprising: (a) in response to a first user tapping the send button for the messaging host to transmit the branded refund-confirmed message with a URL encoded with the temporary table data, the active core receives a callback confirmation, updates the order history, return-refund data, return-shipment table, and SKU table in the first session data model cache, deletes the temporary table and assigned cache to save device space, and then opens the first session app to the order history UI to display the return shipment and return-refund summary; and (b) in response to a callback triggered by a second user tapping the received branded refund-confirmed message on the second device, the active core performs a tap-to-update process, decoding the data in the URL, calling the action-key-based smart service API to update the order history, return-refund data, return-shipment table, and SKU table in the second session data model cache, then the core saves the temporary table as a journal entry for audit trail, and then opens the second session app to the order history to display the return shipment and return-refund summary. This temporary table approach can efficiently handle complex data processing tasks to help client-server systems to offload intensive data processing tasks.

15. The system as in claim 8, wherein a second session app is configured to identify a second user's multiple devices by unique PINs, appoints the second user on the first-registered device to act as the distributor and the ones on storefront devices to act as publishers, and presents role-based UIs for the distributor to create working copies and distribute production copies of assigned stores to a group of publishers for read-only access, and for authorized publishers to customize promotions by user groups created on their storefront stores and publish them with respective production copies to their subscribers belonging to many user groups to shop across stores with a method comprising: (a) in response to the distributor tapping the assign button in the store manager UI, the core generates and sends the branded assignment-list message to a group of publishers via a tap-to-message process; in response to each publisher tapping the received message, the core performs a tap-to-update process to update the store-device assignment list in the second session data model cache on the respective storefront device to be used for planning; (b) in response to each publisher tapping the received branded store message sent by the distributor, having the attachments copied to and deserialized in the container app, and tapping the message again in the transcript, the core performs tap-to-update process to launch the production copy of the store in the second session app for read-only review; (c) in response to each publisher tapping the subscribe button in the group manager UI, the core generates and sends a subscription list of reviewed stores subscribed by user groups created by a respective publisher to the distributor, who verifies the list through a tap-to-update process and replies with a branded approved message via a tap-to-message process to the respective publisher, granting privileges to promote and publish the stores on the subscription list to the subscribed groups; (d) in response to each publisher tapping the received approved message, the second session app activates the promotion manager, publish button, order history, and sales analytics UIs for each publisher to add promotions customized by user groups to a respective production copy, and then publish the store to subscribed user groups; and (e) in response to each subscriber tapping the received branded store message in transcripts sent by a publisher, having the attachments copied to and deserialized in the container app, and tapping the message again in the transcript, the core performs a tap-to-update process to launch the first session app that opens the store homepage with data retrieved and populated across shopping UIs. Moreover, subscribers belonging to multiple groups can repeat the process to access more stores on their own devices for shopping and tracking with respective publishers.
